(19) United States
(12) Patent Application Publication
(10) Pub. No.: US 2017/0004141 A1
(43) Pub. Date: Jan. 5, 2017

(54) COMPUTER SYSTEM AND METHOD FOR CREATING A STORE OF INFORMATION TOKENS

(71) Applicant: LOCPIN LTD, Hailsham Sussex (GB)

(72) Inventors: Roberto DAVENPORT, Hailsham Sussex (GB); Guy DAVENPORT, Hailsham Sussex (GB)

(21) Appl. No.: 15/113,360

(22) PCT Filed: Jan. 19, 2015
(86) PCT No.: PCT/GB2015/050111

§ 371 Date: Jul. 21, 2016

(30) Foreign Application Priority Data
Jan. 23, 2014 (GB) 1401126.6

(51) Int. Cl. G06F 17/30; H04L 29/08

(52) U.S. Cl. CPC G06F 17/30091; H04L 67/24; H04L 67/20; H04L 67/141; H04L 67/1097; H04L 67/18

(57) ABSTRACT

The present disclosure provides a computer implemented method of creating a first user information token in a computer system. The method includes establishing a first user session for a first user having a presence in the computer system comprising a first user data structure. The first user data structure includes first user meta data indexed by a first user identity responsive to first user input. The method further includes receiving content input by the first user; generating a unique user information token; storing the content in a first user modifiable content storage structure locatable by the user information token; and storing the user information token in a first user token data structure indexed by the first user identity.

### CROSS-REFERENCE TO RELATED APPLICATIONS

The present application is a national stage application of PCT Patent Application No. PCT/GB2015/050111, filed Jan. 19, 2015, which claims priority to UK Patent Application No. 1401126.6, filed Jan. 23, 2014, the contents of each of which are hereby incorporated by reference in their entireties.

### BACKGROUND OF THE DISCLOSURE

1. Field of the Disclosure

The invention relates to content based services and, particularly, but not exclusively, to a computer system and method for providing content based services.

2. Description of Related Art

Code based systems for specifying a geographic location which does not require a complete address are known. One method of specifying such a geographic location has been used for many years in the UK by the Royal Mail since its introduction over the period between 1959 and 1974 and is known as the “postcode” system. The UK is split into geographic areas which are specified by their postcode with an average of 15 addresses and a maximum of 100 addresses per postcode. However, a postcode can be identical over an area of several square kilometres so a postcode describes a user's location only up to the wide area in which they are situated. Consequently, the postcode must be supplemented by full address details in order for a particular building to be identified.

In Ireland, a different system is used in which a commercial provider (Loc8) allows a user to identify a location on a digital map by way of inputting an address to which the provider assigns a code. The code can then be used to find that location on the map. The code is specific to that location on that digital map. Although a user initiates the creation of the location code they have no subsequent control over it and it remains the code for the map location specified by the user.

Additionally, an application known as “PinDrop” from Caffeinehit Limited of 54 Rivington Street, London, UK, provides a service by which a user may identify a location on a digital map and “drop a pin” onto the map thereby marking the location. The PinDrop application allows a user to label 406 a dropped pin on a location.

An application known as “Addy” provides a service that a location may be labelled and posted to a website.

The increasing mobility of society and the dynamic nature of both the domestic and the working environment has led to a growing need for services that are both flexible and accurate with respect to the location of a user.

In such environments, providing a location of an individual or organisation can represent a complex challenge particularly if an individual may frequent many different locations or require very specific and accurate location based services. One example may be where an individual works at one or more office locations, at home or at a family member's residence or indeed elsewhere. That individual may not wish to receive courier deliveries of a work parcel at their home address and may not wish to receive private mail at their work addresses. Additionally, a user may wish to specify where they would like postal or courier deliveries to be delivered if they have more than one entrance or more than one letterbox for the deposit of mail at the general location.

Another example is where a conventional address, for example 10 Downing Street, London, is not the address for deliveries. Instead, deliveries are made to an adjacent side door or back entrance located a few yards from the conventional address location.

Aspects and embodiments of the invention have been devised with the foregoing in mind.

### SUMMARY OF THE DISCLOSURE

Viewed from a first aspect there is provided a computer implemented method of creating a first user information token 405 in a computer system, the method comprising:
establishing a first user session for a first user having a presence in the computer system comprising a first user data structure including first user meta data indexed by a first user identity responsive to first user input;
receiving content input by the first user;
generating a unique user information token 405;
storing the content in a first user modifiable content storage structure locatable by the user information token 405; and
storing the user information token 405 in a first user token data structure 402 indexed by the first user identity.

Viewed from a second aspect, there is provided a computer system for creating a first user information token, the system operative to:
establish a first user session between a terminal and a server for a first user having a first user data structure on a database stored on the storage medium including first user meta data indexed by a first user identity responsive to first user input at the terminal device;
receive content at the server;
generate a unique user information token at the server 102;
store the content a first user modifiable content storage structure locatable by the user information token;
store the user information token in a first user token data structure indexed by the first user identity.

A method or system such as referred to above may provide a technical environment for storing user content identifiable by a unique token acting as a key to that content. Search and retrieval of content may be achieved solely by way of the token and users may pass tokens to third parties to provide them access to the content. The token acts as a separator between the user identity data (e.g. user meta data) and the content and therefore the content may be anonymous in that a third party user of the content need not know the identity of the user owning or controlling the content, or to whom the content relates.

Although an example is given below of content in the form of location data, the content may relate to any type of data such as financial data, tax data, club membership data, collections of images, marketing data, chemical measurements, data resulting from simulation of mechanical and physical systems, Internet preferences and material data.

Indexing the first user editable content storage structure by the user information token 405 may provide for efficient searching and retrieval of the content from the computer system.

The user information token may be assigned to the content and/or content storage structure. Optionally or additionally, the user information token is stored in the content storage structure.

The content in the content structure may be updated responsive to input from the first user. Thus, a third party in possession of the user information token need not be notified of a change in the content. Use of the same token will automatically provide access to the updated content. This may be particularly useful if a third party uses the content intermittently or is not in regular contact with the first user and so would not be easily informed of updated content by the first user.

The first user may assign a first character string to the information token 405, i.e. a label, which assists the first user in identifying the content. For example, the character string may be a meaning sequence of letters such as “investments” or “tax details”.

In a particular embodiment, the method and system are configured for receiving from the first user a unique third party information token 405 indexing a third party content storage structure, typically within the computer system; and storing the third-party information token 405 in a third party information token 405 data structure indexed by the first user identity. That is to say, the first user may keep a record of third party information tokens in their part or “domain” of the computer system.

Viewed from a third aspect there is provided a computer implemented method of creating a store of information tokens 405, comprising:
establishing a first user session for a first user having a presence in the computer system comprising a first content storage structure including first user meta data indexed by a first user identity;
receiving from the first user an unique third party information token 405 indexing a third party content storage structure; and
storing the third party information token 405 in a third party information token 405 data structure indexed by the first user identity.

Viewed from a fourth aspect, there is provided a computer system for creating a store of information tokens, the system operative to:
establish a first user session for a first user having a presence in the system comprising a first content storage structure including first user meta data indexed by a first user identity;
receive from the first user an unique third party information token 405 indexing a third party content storage structure; and
store the third party information token 405 in a third party information token 405 data structure indexed by the first user identity.

The first user may also assign a second character string to the third party information token 405 stored in their domain.

In this way, a first user may apply a meaningful and possibly non unique, label to their and third party information tokens stored in the first user's domain. Since such labelled information tokens are only accessible in the first user's domain they need not be unique within the computer system. Thus, a user may apply and use meaningful labels to unique tokens without needing to check if such labels are unique.

Viewed from a fifth aspect there is provided a computer implemented method of accessing information stored in a computer system comprising a store of information tokens, the method comprising:
receiving a search query comprising one or more search terms;
searching first user data structures and returning at least one user information token 405 stored in an information token data structure indexed by the first user identity.

Viewed from a sixth aspect there is provided a computer system for accessing information stored in a data store, the system operative to:
receive a search query comprising one or more search terms;
search first user data structures and returning at least one user information token stored in an information token data structure indexed by the first user identity.

Thus the computer system may be searched to find a user information token based on a suitable and searchable criterion. Optionally or additionally the search may return at least one third party information token.

Viewed from a seventh aspect there is provided computer implemented method of accessing information stored in a computer system comprising a store of information tokens, the method comprising:
receiving a search query comprising a user or third party information token;
returning content stored in an information data structure indexed by the user or third party information token.

Viewed from an eighth aspect there is provided a computer system for accessing information stored in a data store comprising a store of information tokens:
receive a search query comprising a user or third party information token;
return content stored in an information data structure indexed by the user or third party information token.

A party in possession of an information token, user or third party token, and having access or user rights in the computer system may retrieve content based solely on an information token. Such content may be retrieved without any knowledge of the identity of the user to which the content relates or who owns or controls the content. Thus, the content may be anonymous.

Suitably, the content stored in a content storage structure identified by an user information token may be modified responsive to a request from the user controlling the user information token identifying the content storage structure in which the content to be modified is stored. Meta data about the content stored in a content storage structure may be stored in the said content storage structure responsive to a user request. Thus, the overall content may be enhanced by the meta data.

Typically, the method and system are configured to restrict storing the meta data responsive to a request from a user controlling the user information token indexing the said content storage structure. Thus, the owner or person having control of the content also controls what meta data about the content is stored with the content.

Suitably, the meta data includes one or more of the following: privacy rules defining rights of access to the content or a part thereof; an image; a QR code; and notes. Setting privacy rules is particularly useful as they may be set dependent upon an accessing party's identity thereby ensuring that party's see only those parts of the content the owner or controller of the content wishes them to see.

Further suitably, the content comprises digital map location data. Uploading digital map location data enables the user to generate a unique modifiable token which points to accurate location information about the user. The digital map location data may comprise data corresponding to an indicated location on a digital map which may be satellite navigation location data. This enables the user to indicate the location which they would like the unique modifiable token to point to.

The content may comprise metadata in the form of, for example a description of the locations as “home” or “home delivery”. This enables the user to store a detailed description of the location which can be accessed when the content storage structure is accessed.

### BRIEF DESCRIPTION OF THE DRAWINGS

One or more embodiments of the present invention will now be described, by way of example only, and with reference to the following figures in which:

FIG. 1 schematically illustrates a computer system in accordance with an embodiment of the present invention;

FIG. 2 schematically illustrates a server cluster in accordance with an embodiment of present invention.

FIG. 3 schematically illustrates a database server in accordance with an embodiment of the present invention.

FIG. 4 schematically illustrates a web server and a web interface in accordance with an embodiment of the present invention.

FIG. 5 schematically illustrates a store containing a store of web documents.

FIG. 6 is a sequence diagram illustrating the registration of a user on the computer system in accordance with the present invention.

FIG. 7 illustrates a user interface that may be used to enable a user to establish a presence in the computer system;

FIG. 8 is a sequence diagram illustrating the validation of a user on the computer system in accordance with the present invention.

FIG. 9 is a sequence diagram illustrating the steps involved in the generation of a location information token in accordance with the present invention;

FIG. 10 is a schematic illustration of a relational database structure in accordance with an embodiment of the present invention;

FIG. 11 is a schematic illustration of a user data structure in accordance with an embodiment of the present invention;

FIG. 12 is a schematic illustration of a user token data structure in accordance with an embodiment of the present invention;

FIG. 13 is a schematic illustration of a third party location information data structure in accordance with an embodiment of the present invention;

FIG. 14 is a schematic illustration of a location data structure in accordance with an embodiment of the present invention;

FIGS. 15 a to h are sequence diagrams illustrating the interaction between the elements of the computer system in accordance with an embodiment of the present invention;

FIG. 16 is an illustration of a user interface which may be used to generate a location information token in accordance with an embodiment of the present invention;

FIG. 17 is an illustration of a user interface which may be used to adjust the position data using a digitally generated map in accordance with an embodiment of the present invention;

FIG. 18 is a schematic illustration of a user interface which is provided by the terminal to display the location data retrieved by the user and a corresponding input region to place a label in accordance with an embodiment of the present invention;

FIG. 19 is a schematic illustration of a user interface which is provided by the terminal to display the successful access to the computer system setting out options for other operations the user may wish to carry out using their session in accordance with an embodiment of the present invention;

FIG. 20 is a schematic illustration of a user interface displayed by the terminal when the user indicates a desire to access location data in accordance with an embodiment of the present invention;

FIG. 21 is a schematic illustration of a user interface providing the user with the opportunity of saving a label for a location information token in accordance with an embodiment of the present invention;

FIG. 22 is a schematic illustration of a user interface which enables the user to view the location information tokens they have stored on the computer system in accordance with an embodiment of the present invention;

FIG. 23 is a schematic illustration of a user interface which enables the user to edit and delete location data corresponding to a location information token according to an embodiment of the present invention;

FIG. 24 is a schematic illustration of a user interface that enables a user to save location data to contacts or to interface with a satellite navigation application according to an embodiment of the present invention;

FIG. 25 is a schematic illustration of a user interface which enables the user to edit aspects of the data stored in a location information data structure according to an embodiment of the present invention;

FIG. 26 is a schematic illustration of a user interface which may be used to edit a label corresponding to a third party location information token according to an embodiment of the present invention;

FIG. 27 is a schematic illustration of an interface which enables the user to search the relational database according to an embodiment of the present invention;

FIG. 28 is a schematic illustration of an interface which enables the user to store the results of a search for a location information token in accordance with an embodiment of the present invention.

### DETAILED DESCRIPTION OF THE DISCLOSURE

A computer implemented method in accordance with an embodiment of the invention will now be described with reference to an illustrative computer system 100 on which the method is implemented.

### Computer System

FIG. 1 schematically illustrates the computer system 100, which may be in a networked environment, comprising a terminal 101, a server cluster 102 and a database 103.

The terminal 101 is operative to communicate with the server cluster 102. The terminal 101 may, for example, be a mobile computing device such as a smartphone, a tablet or a laptop computer; or a desktop computer. Any other type of device that can communicate with a server cluster 102 may also be used. In the illustrated example, the terminal 101 is a mobile computing device operable to receive input from a user. The mobile computing device comprises a processor 110 operative to execute instructions, stored locally for example, to instantiate an application program 111 for bringing an embodiment of the invention into effect.

The processor 110 is configured by the application program instructions to interpret the input from a user and to provide instructions to a transmitter and receiver to transmit information to and receive information from the server cluster 102 respectively. The mobile computing device will generally communicate wirelessly with the server 102 but other types of communication medium such as, for example, fibre optic or twisted-pair copper wire, may be used without stepping outside of the scope of the subject matter disclosed herein.

The application program comprises routines which, when executed on the terminal 101, provide a web browser through which the user can enter input.

The server cluster 102 comprises a web interface 104, a web server 105, an application server 106, a database server 107, an application interface 108 and a database interface 109. The web server 105, the application server 106 and the database server 107 each comprise a processor arranged to receive input from and transmit output to a corresponding interface.

The web server 105 is operative to receive requests from the terminal 101 via the web interface 104 and to respond to the requests from the terminal 101 via the web interface.

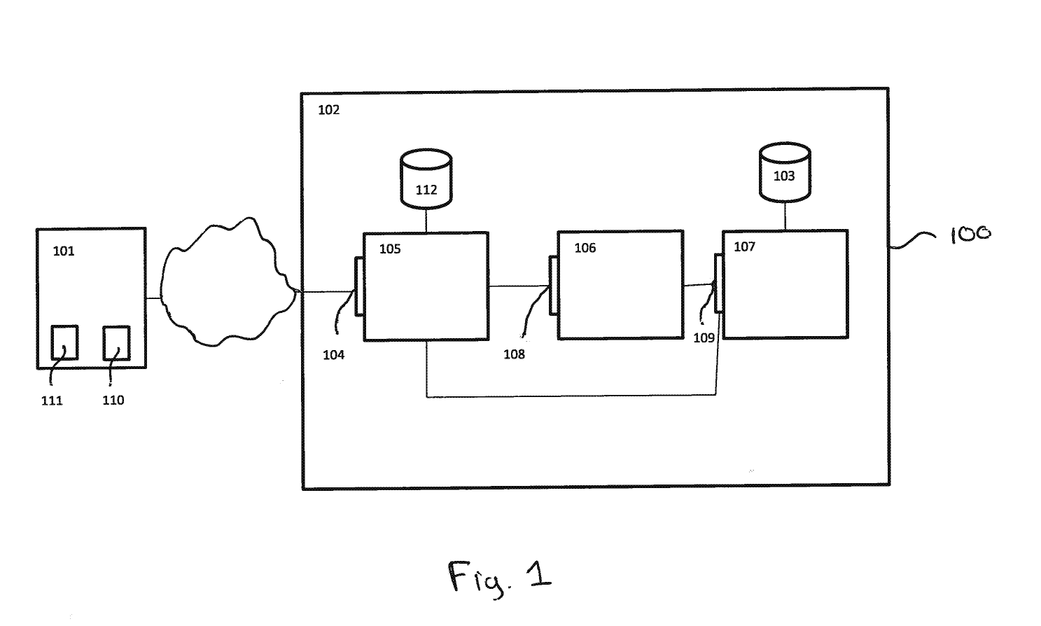

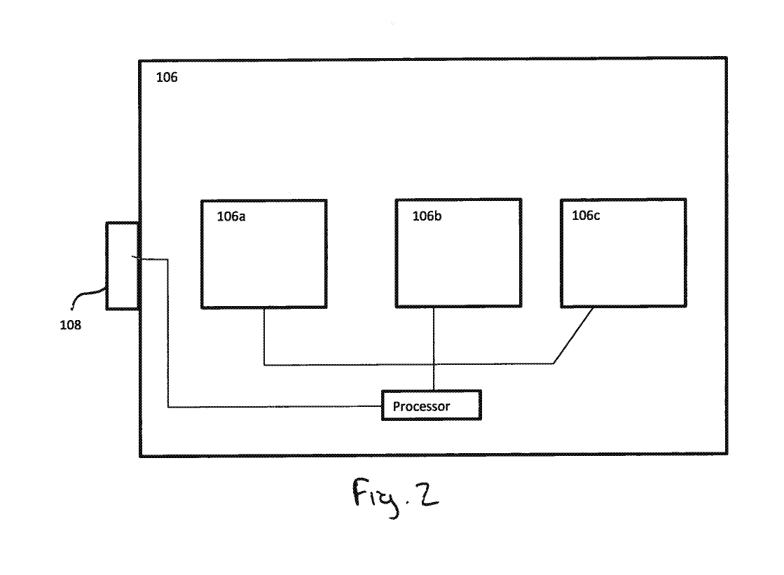

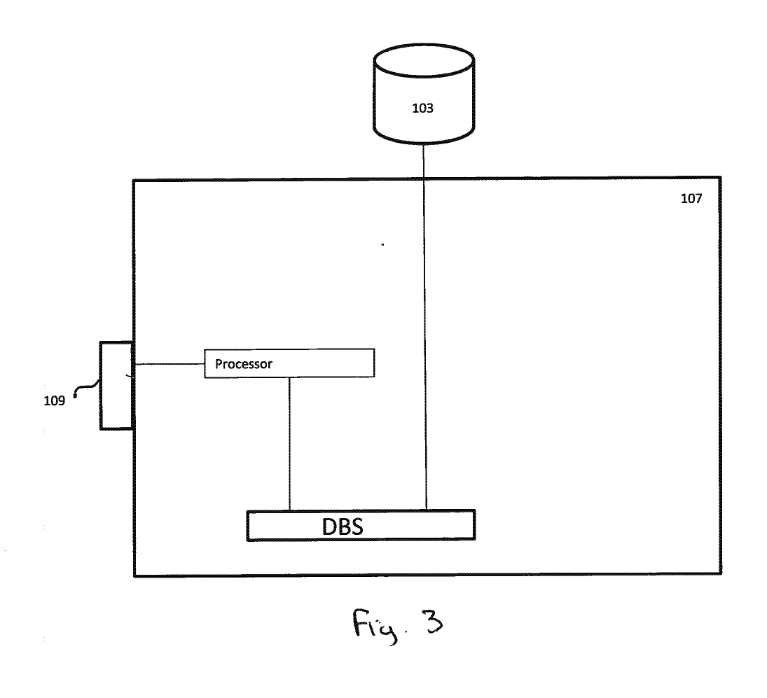

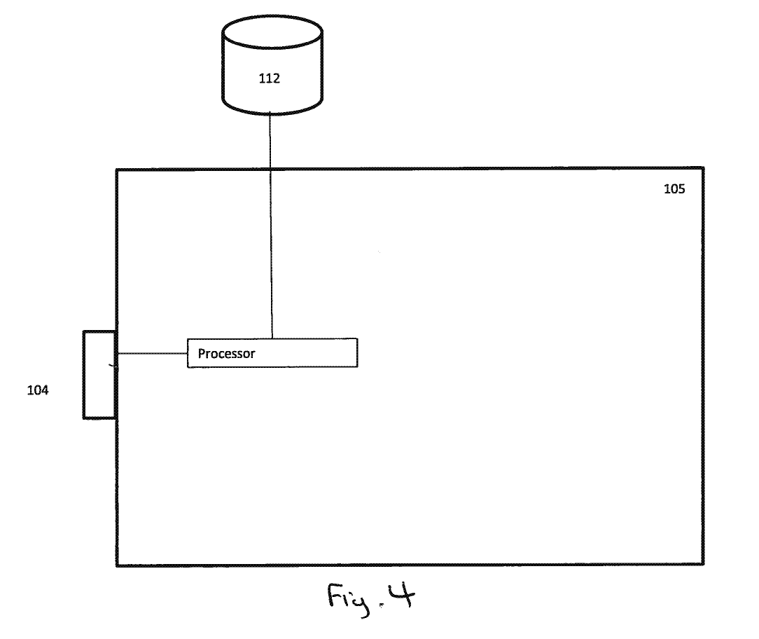

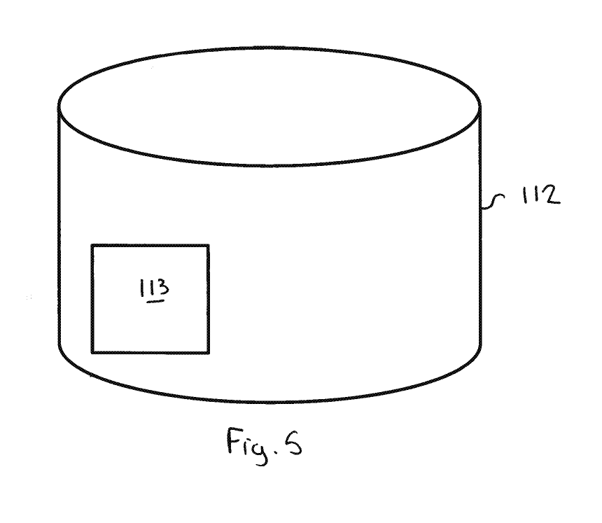

The web server is schematically illustrated in FIG. 4. The web server 105 is operative to configure and deliver content to the terminal in the form of web documents, such as html documents, for display at the terminal 101. The web documents may comprise input regions operative to receive user input at the terminal and may also comprise text output. The web documents may also comprise multiple frames to accommodate frames corresponding to different content sources within the document such as images and digital maps. Some of the web documents may be stored in template form in a store 112 (schematically illustrated in FIG. 5 which can be accessed by the web server. The template of a web document may include text fields and input regions to be configured by the web server. The store of web documents 113 includes a name document, a name confirmation document, a validation document, a confirmation document, a data request document, a data entry document, a label entry document, a validation failure document, a data editing document, an access confirmation document, an incorrect password document, a location information store document, a data access document, a data display document, a location data document, a label edit document and a searching document.

The web server 105 is also operative to receive content uploaded by users at the terminal 101 via the web interface 104 and to receive data submitted through web pages at the terminal 101 via the web interface 104.

The web server 105 is further operative to communicate with the application server 106 via the application interface 108.

The application server 106 is schematically illustrated in FIG. 2. The application server 106 is operative to respond to requests from the web server 105 via the application interface 108. The processor at the application server 106 is operative to execute instructions for a plurality of modules stored in memory which each relate to an aspect of the functionality of the application program 111. The modules comprise a name generation module 106a, a validation module 106b and a token generation module 106c

The database server 107 is schematically illustrated in FIG. 3. The database server 107 is operative to execute routines forming a database management system (DBS) for the database 103. The DBS is operative to control the organisation, storage, retrieval, security and integrity of the data in the database 103. The DBS is further operative to edit and store data in the database 103 responsive to a request from the server application.

The database 103 may be hosted on the server 102 or stored at a geographical location separate from that of the server 102 and coupled to the server 102 by a dedicated connection or a network connection such as a Local Area Network (LAN), Wide Area Network (WAN), Metropolitan Area Network (MAN) and/or via the Internet The database 103 may run as an application distributed over a network of connected computers, i.e. in the cloud.

### Registration

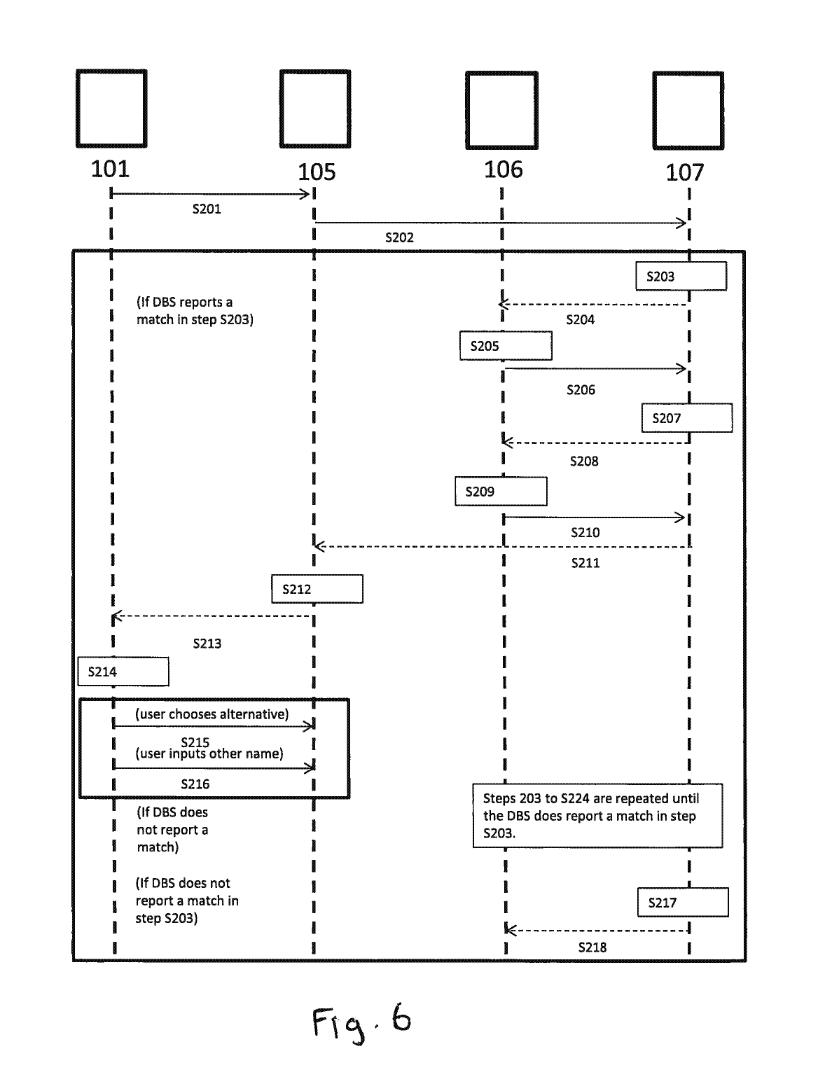

The process of registration is described using the sequence diagram in FIG. 6.

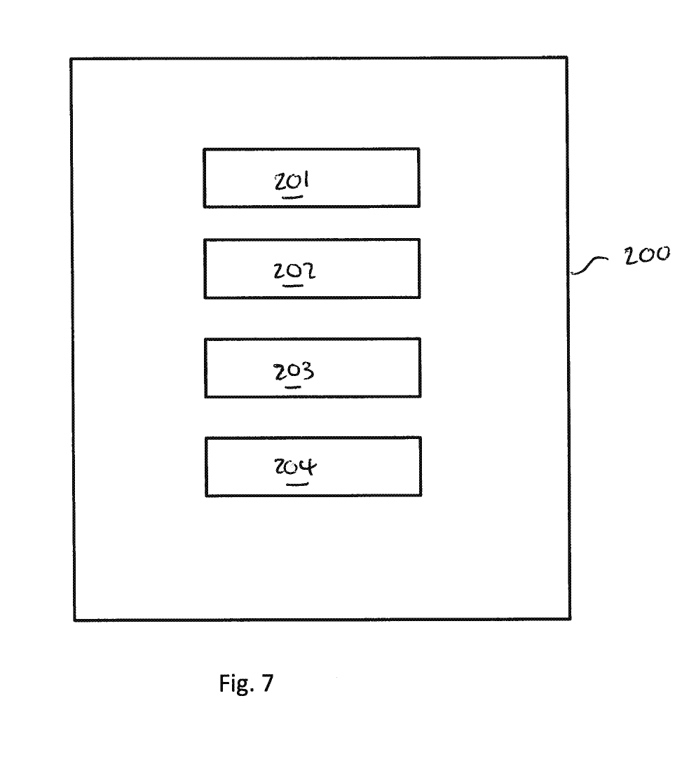

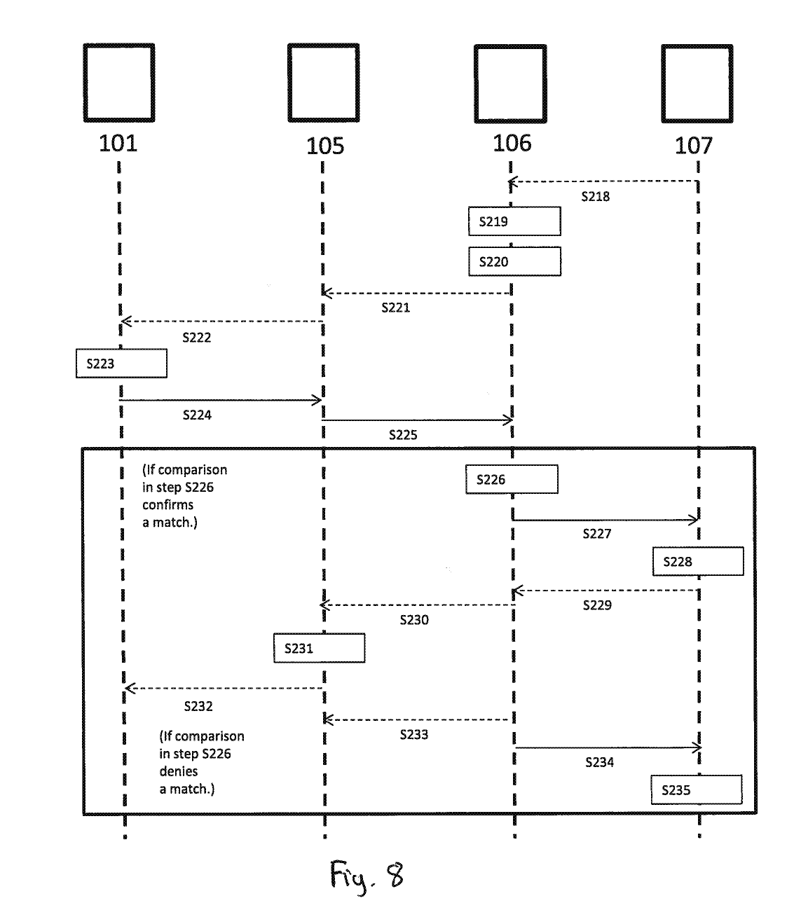

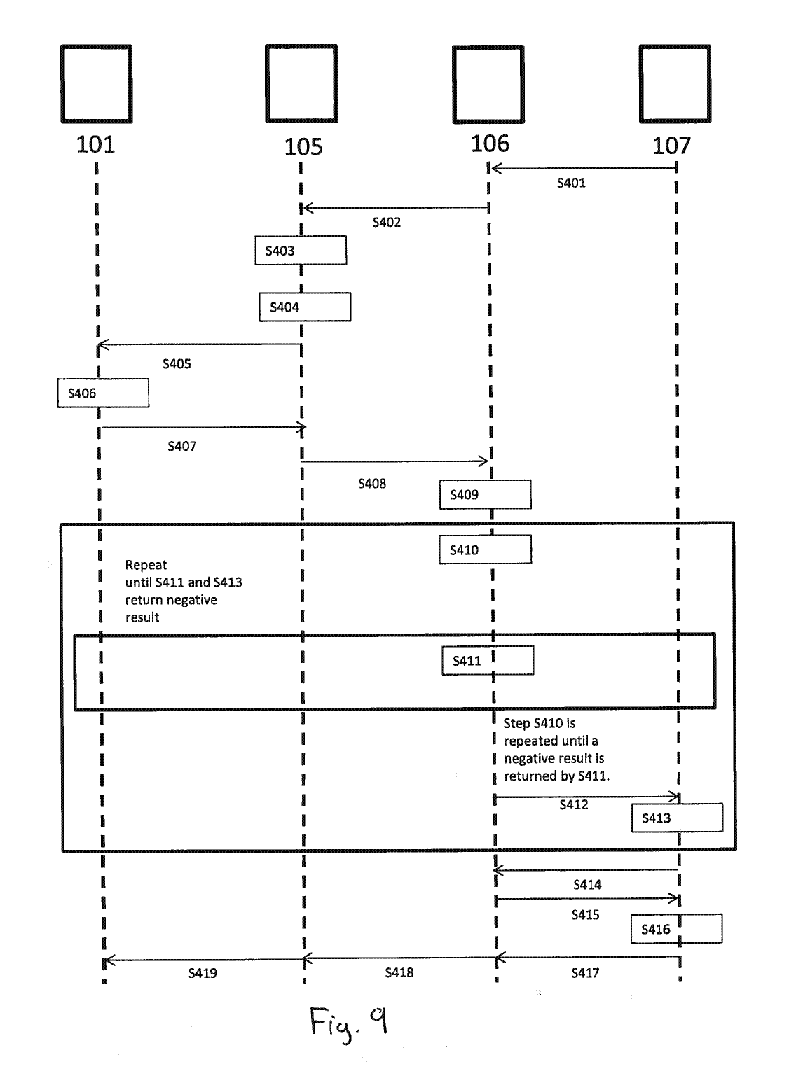

Initially, a user establishes a presence in the computer system by registering on the database 103 by establishing communication with the server cluster 102 and transmitting user data to the server. The new user establishes communication with the server using a user interface 200 displayed on the terminal 101 as illustrated in FIG. 7. The user interface 200 may be generated by a web browser running on the terminal 101 or the application program 111 which may be downloaded from a generic application store.

The user enters their username into input region 201, their password into input region 202, confirmation of their password into input region 203 and their email address into input region 204. This data is then transmitted to the web server 105 via the web interface 104 in a step S201.

The data transmitted to the web server from the terminal 101 in step S201 may additionally or optionally comprise user metadata such as contact details for the user e.g. a telephone number, an email address, a home address and a work address. These contact details may be input into a separate user interface displayed on the terminal 101 or on the same user interface 200 (as shown in FIG. 7) as for the username 201, the password 202, password confirmation 203 and email address 204.

Responsive to receiving the data from the web server 105, the web server 105 issues a request to the database server via the database interface 109 in a step S202 for the DBS to interrogate the database 103 for a registered user with a user name corresponding to the user name input into input region 201. The DBS queries the database 103 for a registered user with the user name entered into input region 201 in a step S203.

If the DBS reports a match, the database server 107 in a step S204 issues a request to the application server for alternative user names that are similar to the user name input into input region 201. Responsive to receiving the request in step S204, the processor in the application server issues instructions to a name generation module to generate a plurality of alternative names that are similar to the user name entered at the terminal 101 in a step S205.

The name generation module comprises a series of instructions which, when executed, generate a plurality of alternative user names. The generation of alternative user names may comprise, for example, concatenating the user name with a digit 0-9 to form a list of alternatives and then transmitting a request to the database server 107 for the DBS to check each of the list of alternatives against the user names that are already in use in a step S206. Responsive to receiving the request from the application server 106 in step S206, the database server 107 instructs the DBS to iteratively query the relational database to see if any of the list of alternative user names are already in use in step S207. The DBS then issues a report in step S208 which is communicated to the application server 106 indicating which of the alternative user names are already in use and which are not.

If the number of alternative user names that are not in use falls below a fixed threshold, 5 say, then the application server may re-issue instructions to the name generation module to generate more alternative user names in a step S209.

The generation of alternative user names in step S209 may concatenate the user name inputted into input region 201 with a second digit (0-9) to generate a further list of alternative user names. The generation of the further list of alternative user names comprises the repetition of steps S205 to S208.

Upon generation of a number of alternative user names not in use above the threshold, the application server 106 then responds to the request from the database server 105 with the list of alternative user names to the terminal 101 in a step S210. The database server 107 then responds to the request in S202 with the list of alternative user names via the database interface 109 in a step S211. The response in step S211 also contains a flag indicating that the user name entered by the user is in use and that an alternative must be selected.

The web server 105 then generates a name document for display on the terminal 101 including the list of alternative user names and a message indicating that the user name entered by the user is already taken in a step S212. The document is then transmitted to the terminal 101 via the web interface in a step S213 in response to the request in step S201. The name document is received at the terminal 101 and the processor instructs the application program 111 to display the name document in a step S214.

The name document lists the alternative user names as selectable hyperlinks which, responsive to selection, confirm the alternative user name corresponding to the selected hyperlink as the user selection in a step S215. An input region is also provided where the user can input an alternative which is then transmitted to the web server 105 via the web interface 104 in a step S216 to be checked against the database. If the user inputs their own alternative in accordance with S216, the steps S203 to S214 are repeated until the DBS does not report a match in step S203.

If the DBS returns a report which says that the user name is not already in use responsive to the interrogation of the database 103 in step S203, the user name is temporarily assigned to that user and the DBS instantiates a user data structure in the database 103 in a step S217. The user data structure comprises a plurality of attributes including user identity, first name, last name, preferred name, gender, date of birth, telephone number, email address, password and registration date. The user data structure may also comprise attributes corresponding to the metadata uploaded in step S201. The user name is used to populate the user identity attribute. The password transmitted to the web server in step S201 is used to populate the password attribute. The email address transmitted to the web server in step S201 is used to populate the email address attribute.

Responsive to the instantiation of the data structure, the database server issues a request to the application server for the user to be validated on the system in a step S218.

### Validation

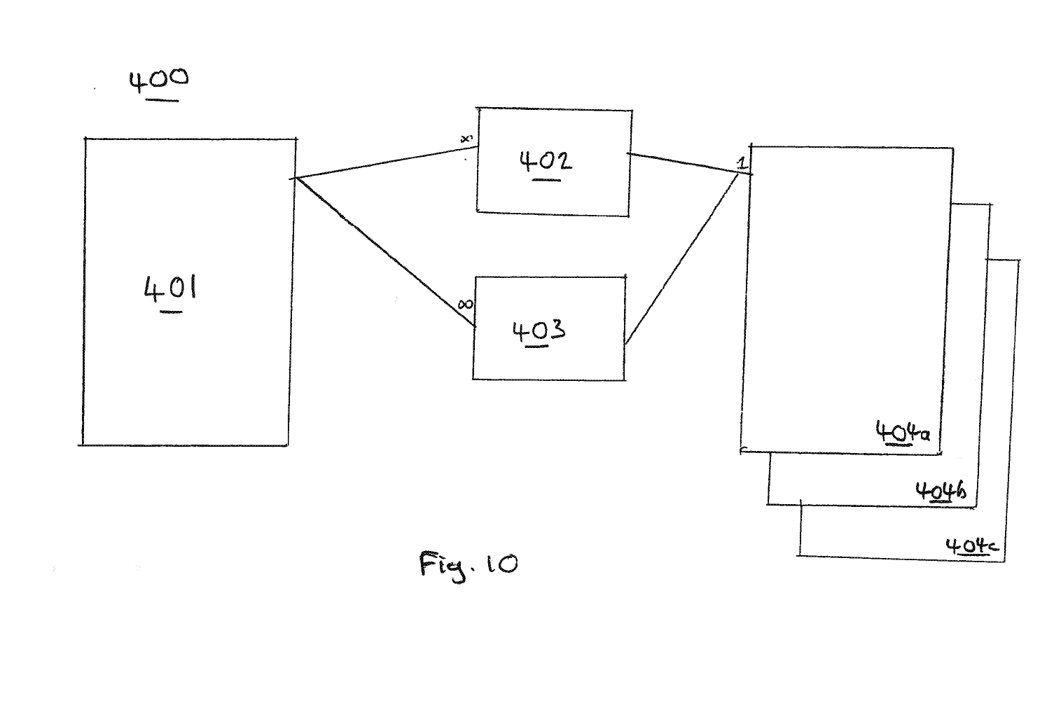

The validation of a user on the system is illustrated with reference to FIG. 8.

Responsive to receiving the request to validate the user in step S218, the application server issues instructions to a validation module in a step S219, the validation module executes a routine to generate a validation code in a step S220. The validation code is transmitted to the web server 105 from the application server 106 with a request that the validation code is included in a validation document to be sent from the web server 105 to the terminal 101 in a step S221. Responsive to receiving the request from the application server 106 the web server 105 transmits a validation document to the terminal 101 including the validation code in a step S222. Responsive to receiving the validation document in step S222, the processor instructs the application program 111 to display the validation document in a user interface with the validation code in a step S223.

The validation document may contain a selectable link which, responsive to user selection thereof, causes the terminal 101 to transmit a request to the web server 105 for validation of the user in a step S224. The validation code is transmitted to the web server via the web interface 104 in step S224. Responsive to receiving the validation code in step S224, the web server 105 then requests confirmation of the correct validation code from the application server 106 via the application interface 108 in step S225. The processor in the application server 106 then instructs the validation module to compares the validation code received from the web server 105 with the validation code that was transmitted to the web server 105 in a step 226. If the validation code received from the web server 105 matches the validation code transmitted with the web document the validation of the user is confirmed. The application server 106 then transmits a request to the database server to instantiate a location data structure, a user token data structure and a third party location information data structure in a step S227. Further details of the location data structure, the user data structure and the third party location information data structure will be described later.

Responsive to receiving the request in a step S227, the DBS populates the attributes in the user data structure relating to the uploaded user metadata including contact details for the user such as a telephone number, an email address, a home address and a work address in a step S228.

The database server 107 then responds to the application server 106 with confirmation that a user token data structure has been generated corresponding to the user name entered at the terminal 101 in a step S229. Responsive to receiving the confirmation in step S229, the application server 106 instructs the web server 105 to configure a confirmation document in a step S230. The web server retrieves a template for the confirmation document from storage 110. The template comprises fields corresponding to the meta data uploaded in step S201 and the user name assigned to the user which populates the User ID attribute in the user data structure. The web server populates the fields in the templates with the appropriate data and also configures a selectable link in a step S231 to be included in the confirmation document which, responsive to selection by the user, initiates the transmission of a confirmation message back to the web server 105. The web server 105 transmits the confirmation document to the terminal 101 via the web interface 104 in a step S232. This establishes the presence of the user in the system 100.

If the comparison in step S226 reveals that the validation code generated in step S220 is not identical to the validation code that was transmitted to the web server 105 in step S225 the application server 106 issues a request to the web server 105 to transmit a document to the terminal 101 in a step S233 which, when displayed on the terminal 101, informs the user that the validation code is not correct and that access to the system is denied. Optionally or additionally, the application server 106 may then transmit a request to the database server 107 in a step S234 requesting that the user data structure instantiated in step S217 is deleted. Responsive to this request being received at the web server 105, the DBS deletes the user data structure generated in step S235.

### Data Structure

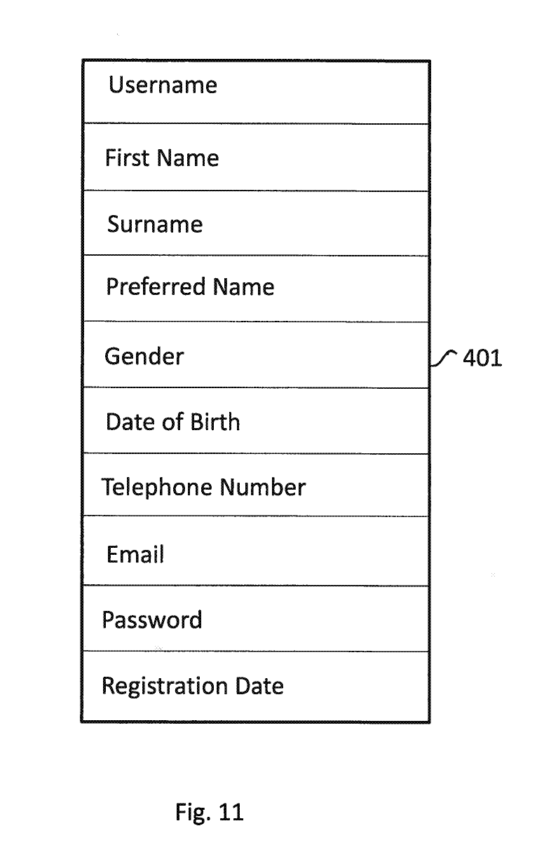

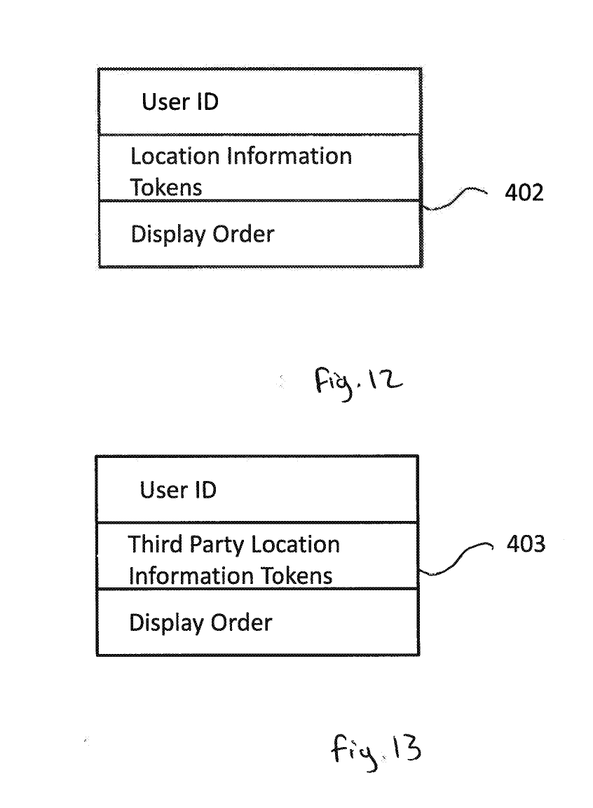

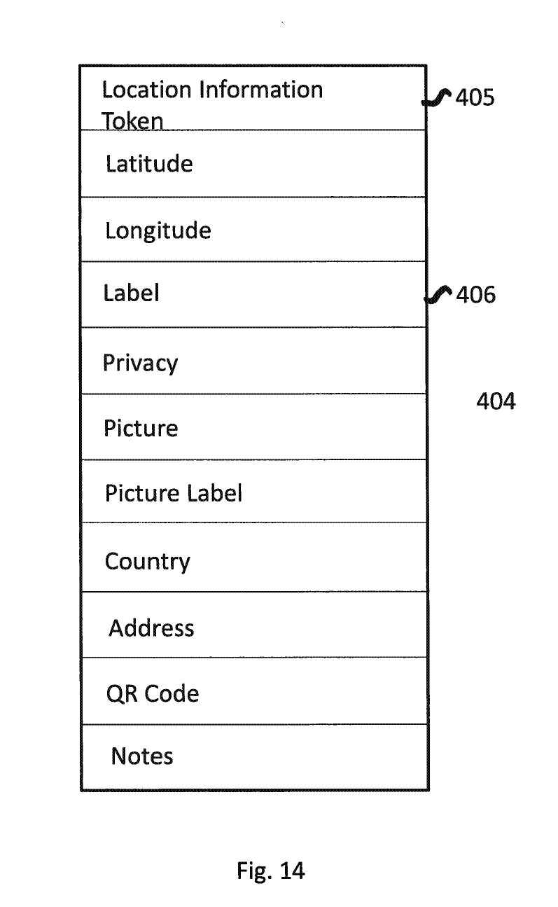

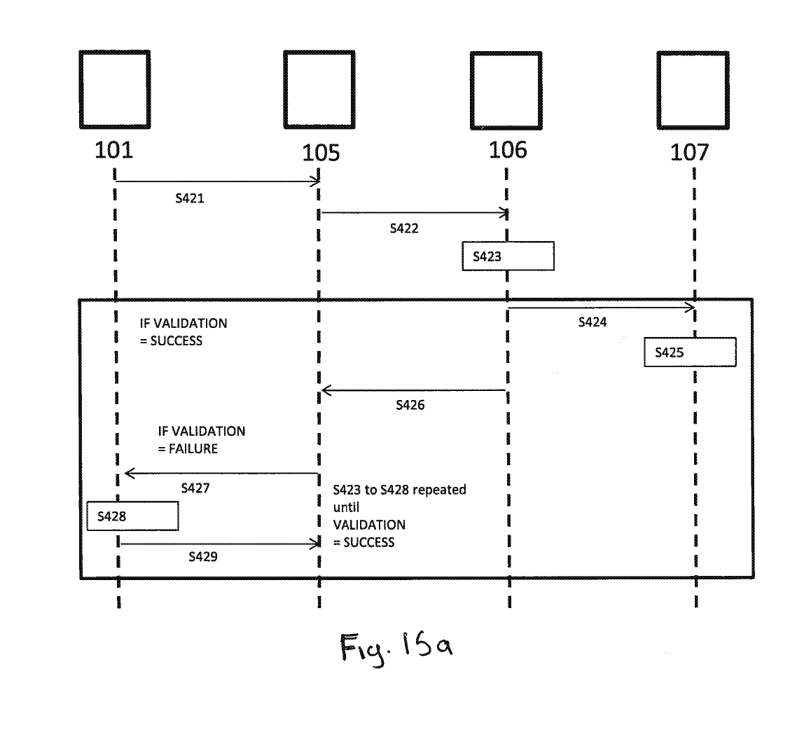

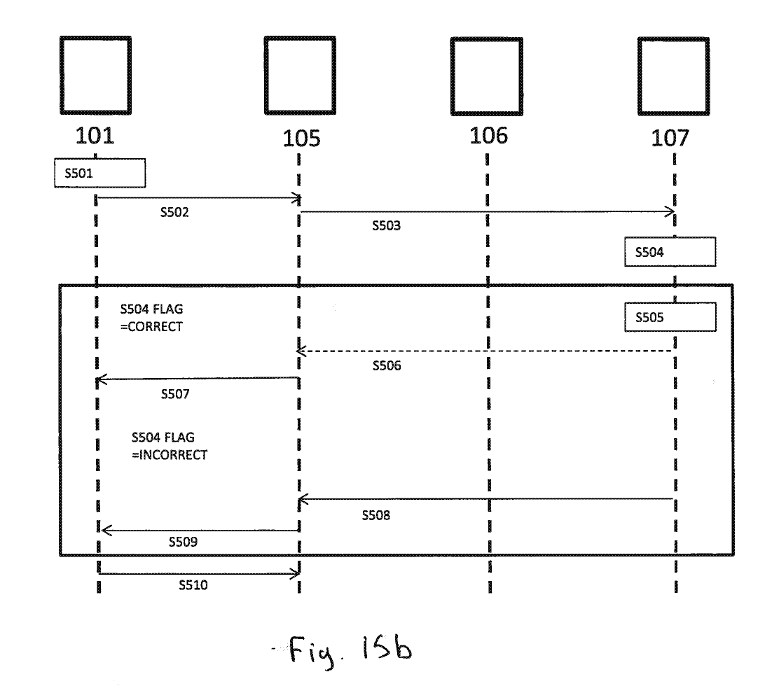

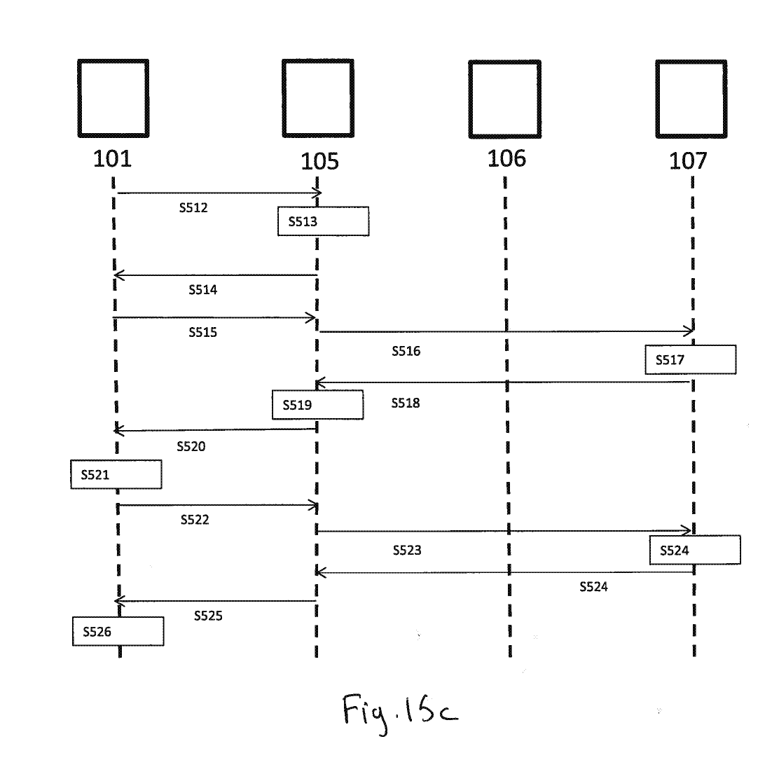

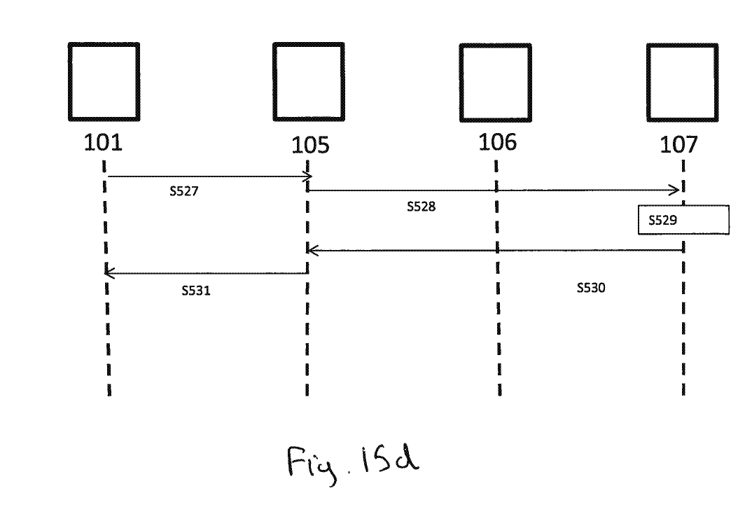

The database 103 will now be described with reference to FIGS. 10 to 14. The database may comprise a relational database structure 400 as illustrated in FIG. 10. The relational database structure will now be described. The relational database structure 400 is managed by the DBS.

The user data structure 401 is editable by the user during a session established in the system 100.

The relational database structure comprises the user data structure instantiated in step S217 and the user token data structure 402, third party location information token data structure 403 and location information data structure 404, also user-editable, instantiated in step S227. The user data structure 401 is added by the DBS as a row to a table of user data structures. Each user data structure corresponds to a user that has already registered a presence in the system 100 in accordance with steps S201 to S234.

The user data structure 401 and the user token data structure 402 are related by the DBS using the user identity, which is populated by the user name, as the primary key. The relationship between the user data structure 401 and the user token data structure 402 is one to many. The user token data structure 402 is schematically illustrated in FIG. 12.

Responsive to the instantiation of the user token data structure 402, and/or the third party location information data structure 403 and/or the location information data structure 404 the database server 107 issues a request to the application server 106 for a location information token in a step S401

### Generation of a Location Information Token

The generation of a location information token is now illustrated using sequence diagram FIG. 9

The application server 106 receives the request from the database server 107 for a location information token via the database interface 109. The application server 106 then issues a request to the web server 105 via the application interface 108 in a step S402 for location data to generate a location information token.

Responsive to receiving the request in step S402, the web server 105 retrieves a template for a data request document in a step S403. The template comprises a body of text requesting the input of location data in order to generate a location information token and input regions for the input of location data. The web server populates the data request document in a step S404 and then transmits the data request document to the terminal in a step S405. Optionally or additionally, the user that has already established a presence in the system in accordance with steps S201 to S234 may initiate a user session to generate a location information token.

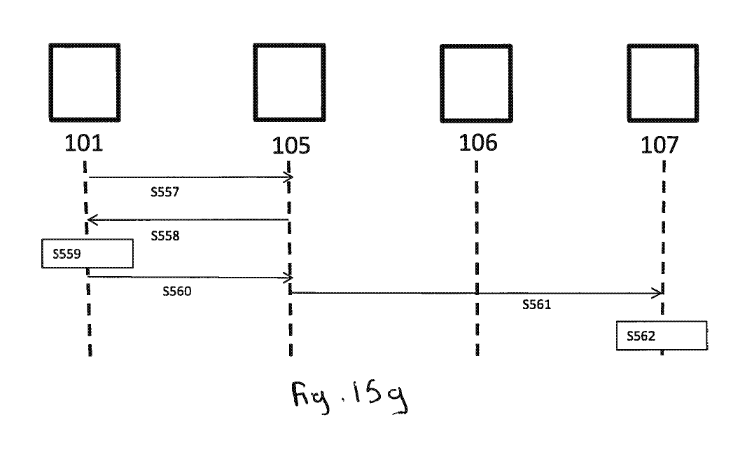

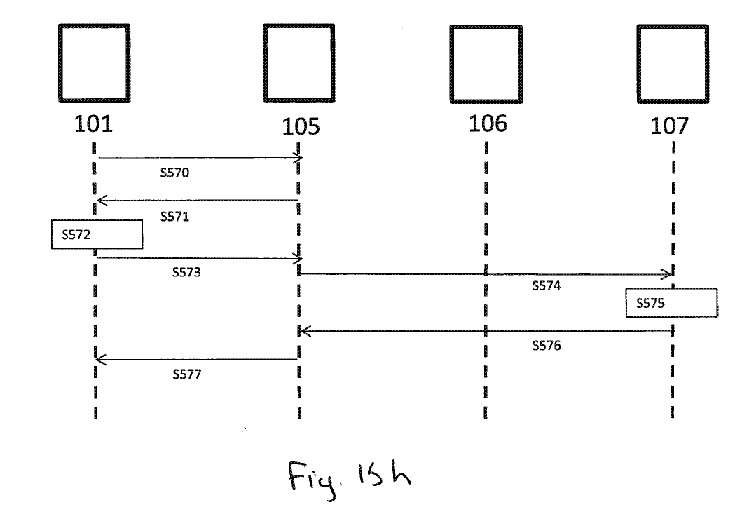

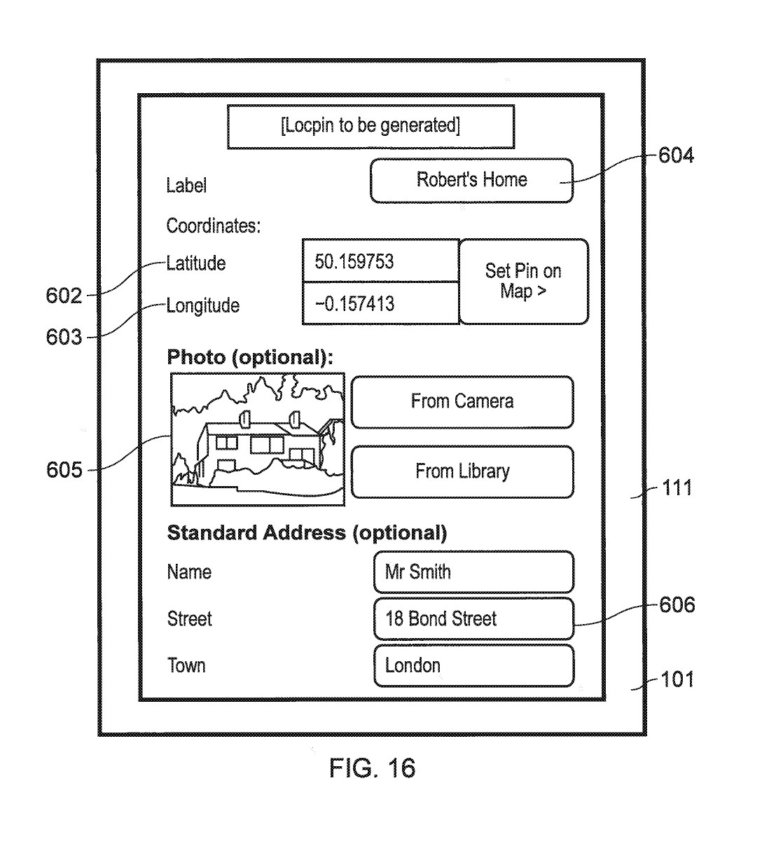

Responsive to receiving the data request document, the processor 110 at the terminal 101 issues instructions to the application program 111 to display the data request document. The data request document is displayed on the terminal in the form of a user interface in a step S406. An example of this user interface 600 is given in FIG. 16.

The user interface 600 comprises input regions which may be populated with values corresponding to digital location data 602, 603 corresponding to the position of the indicated location. The terminal 101 may populate the input regions with location data obtained from a satellite navigation system such as GPS or GLONASS. The population of the input regions with location data obtained from a satellite navigation system may be automatic upon instantiation of the user interface 600 on the terminal 101 or responsive to the user clicking on a selectable link.

The user interface 600 may also comprise input regions for address details corresponding to the location 606 and/or a photograph 605 of the location. The user interface may also comprise a region 604 for inputting a label in the form of an alphanumeric string. The user interface also comprises a selectable link which, responsive to user selection of the selectable link, transmits a request to the web server 105 for the data input by the user to be used to generate a location information token in a step S407. In step S407, the input from input regions 602, 603, 604, 605 & 606 is transmitted to the web server, i.e. the location data values, the address details corresponding to the location, the photograph of the location and the label are transmitted to the web server.

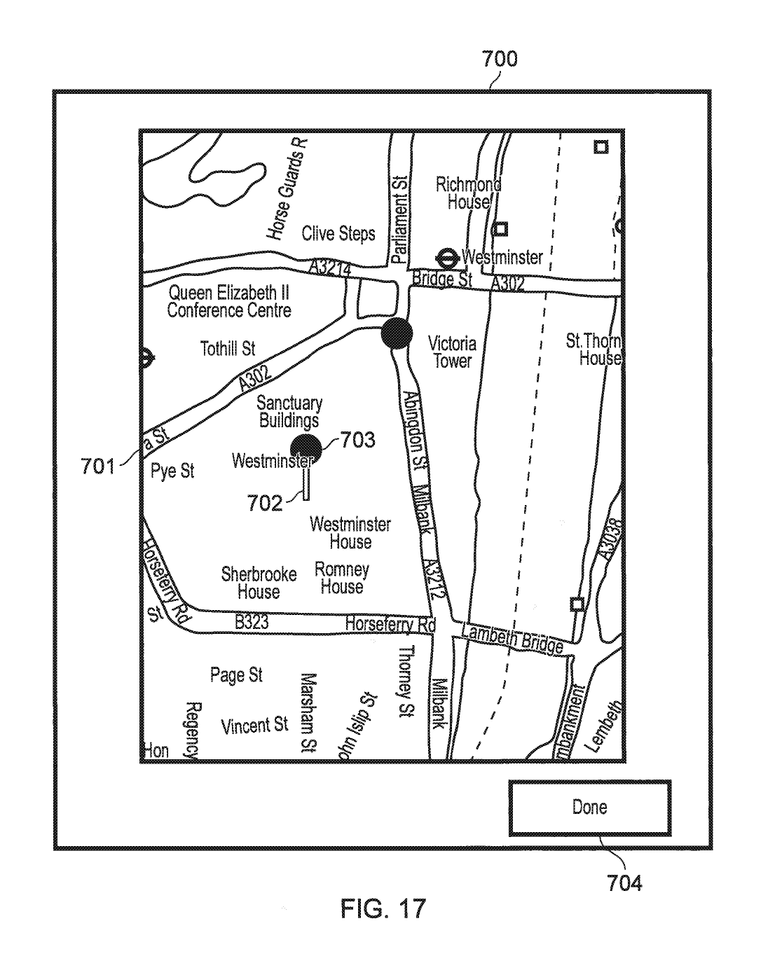

The user interface 600 may also comprise a selectable link which, responsive to user selection of the link, enables a user to adjust the location data input into input regions 602, 603. Responsive to the user selecting the link, the application program 111 is operative to interface with a digital map application, such as Google Maps, to generate a digital map for display in a user interface provided by the application program 111. An example of such a user interface 700 is provided in FIG. 17. The digital map comprises a graphic 703 to indicate the current location. The terminal 101 is operative to interpret user input to adjust the position of the graphic 703.

The user interface 700 comprises a selectable link entitled “Done” 704 to instantiate transmission to the web server 105 via the web interface 104 of location data corresponding to the location as adjusted by the user in step S407.

The location 702 indicated on the map by the graphic 703 when adjusted, i.e. moved, by the user generates a corresponding change in the generated digital map data. For example, a user may wish to move the location to a side entrance of a building outside of which they are positioned.

Responsive to the web server 105 receiving the location data via the web interface in step S407, the web server 105 responds to the application server 106 in step S402 by transmitting the location data received in step S407 to the application server 106 in a step S408. Responsive to receiving the location data, the processor in the application server 106 issues instructions to a token generation module comprising routines for the generation of a location information token 405 in a step S409. The token generation module generates a location information token 405 in a step S410.

The location information token 405 may be a randomly generated, or at least non-predictively generated, hereinafter termed “randomly” generated number generated using a random or non-predictive number generator. The location information token 405 may optionally or additionally comprise a series of alpha-numeric characters comprising letters and randomly generated numbers.

Responsive to generation of the location information token 405, the location information token 405 may be compared using the token generation module 405 with a list of offensive terms in a step S411. If the location information token 405 is found to match one of the listed offensive terms, i.e. the comparison performed in step S411 is positive, then step S410 is repeated until a negative result is returned by the token generation module in step S411.

Responsive to a negative result from the comparison in S411, the application server 106 issues a request to the database server 107 to check that the location information token is not already in use in a step S412. Responsive to receiving this request from the application server 106, the DBS searches the relational database in a step S413 for location information tokens matching the location information token that was generated in step S410.

If the search in step S413 returns an output confirming the presence of that location information token in the database, i.e. a positive result, the database server 107 issues a response to the request of the application server 106 in S412 requesting another location information token in a step S414. Steps S410 to S414 are repeated until steps S411 and S413 return negative results, i.e. the location information token that has been generated in S410 is neither offensive nor already in use. Responsive to the steps S411 and S413 returning negative results, the application server issues a request to the database server for the location information token 405 to be stored in the relational database structure 400 in a step S415. Responsive to receiving this request, the location information token 405 is assigned by the DBS as an index to the location information data structure 404 in a step S416. The location information data structure 404 and the user token data structure 403 are related by the DBS using the location information token 405 as an index. The location information data structure 404 comprises a plurality of attributes relating to the location relating to the location data values 602 & 603, i.e. latitude & longitude, the label 406, a privacy flag, a picture and/or photograph, the country, lines of address relating to the location, a QR code and notes that the user may record in relation to the location information token 405.

The label 406 may be the label that is input in input region 604 and transmitted to the web server in step S407. However, a further chance to store a label is then given to the user that is set out below.

The privacy flag attribute is a flag value that states whether or not the user wishes the location data to be public or not. The privacy flag may take two values: no, i.e. to enable public access, and yes, i.e. to deny public access. Optionally or additionally, the user interface 600 may comprise an input region, which could be a tickbox, where the user may indicate their preference with the default value of the privacy flag being no

The picture and/or photograph attribute is populated with the picture and/or photograph transmitted to the web server in step S407.

The country and lines of address can be taken from input region(s) 606.

The user interface 600 may also optionally or additionally comprise input regions for inputting a QR code or a note that the user may wish to store about the location. The QR code and the notes will be transmitted to the web server in step S407.

The routine for the generation of the location information token 405 in step S410 can be configured to generate a location information token 405 of a length defined by the computer system. For example, the routine may comprise instructions to generate a location information token 405 to be of 6 characters in length. A total of 36⁶ combinations would be possible using just the digits 0-9 and the capital letters A-Z to generate location information token 405. The routine for the generation of location information tokens 405 in step S410 may, for example, comprise instructions to concatenate digits and capital letters so as to form a sequence like ABC123 or to interleave digits and capital letters so as to form a sequence A1B2C3.

If the number of alpha-numeric combinations that can be generated using just the capital letters A-Z and the digits is exhausted, the number of combinations can be expanded further by including lower case letters or by configuring the algorithm to generate a location information token of length 7 or 8 characters.

The generation of the location information token is arranged to generate a unique location information token corresponding to a location. The uniqueness of the location information token enables a location to be identified uniquely within the system using a non-predictively generated alpha-numeric sequence. The user editable location data structure 404 corresponding to the location information token is indexed by the location information token 405, which, due to the uniqueness of the location information token within the system, allows location information to be accessed using the location information token 405 as a primary key in the relational database structure 400.

The digital location data 602, 603 is stored in the user editable location data structure 404 in step S416 by the DBS. The database server then confirms the storage of digital location data 602, 603 by issuing a flag to the application server in a step S417.

Responsive to receiving the confirmation in step S417 the application server 106 issues a request to the web server 105 to transmit a label entry document to the terminal 101 in a step S418. Responsive to receiving the request to transmit a label entry document to the terminal 101, the web server retrieves a label entry document template and populates fields in the template relating to the location data 602, 603, the location information token and an input region operative to receive alpha-numeric input to form a label entry document. Responsive to receiving the request in step S418, the web server 105 transmits the populated label entry document to the terminal.

The terminal receives the label entry document and the processor instructs the application program 111 to display the label entry document on the terminal in the form of a user interface. An example user interface 800 is illustrated in FIG. 18 for the example location information token UT3HY6. The user interface 800 invites the user to store a label corresponding to location information token 405 by providing an input field 801 operative to receive a label.

### Using a Label for the Location Information Token

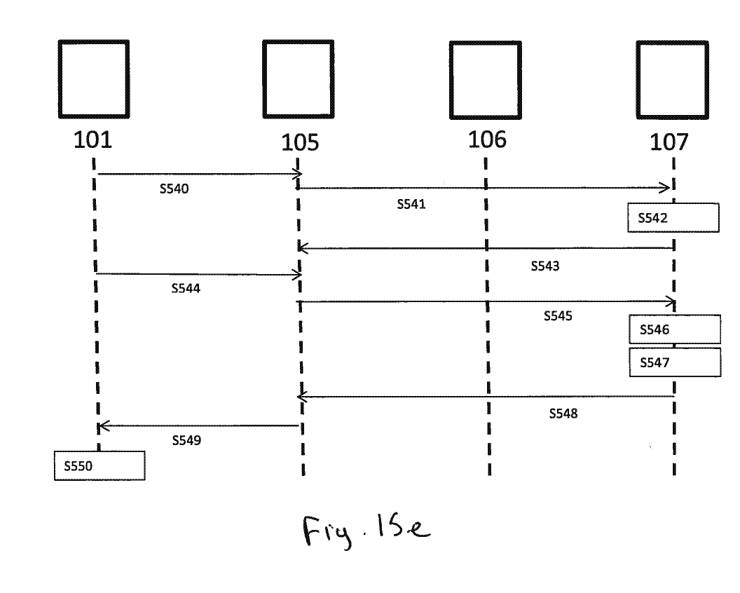

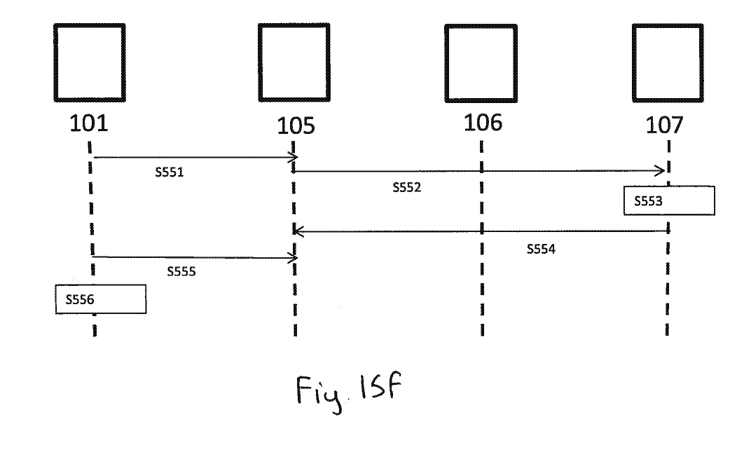

Labelling a location information token is now illustrated using FIG. 15a.

Responsive to the user inputting a label into the input region on the user interface in FIG. 16 (reference numeral 604) or FIG. 18 (reference numeral 801), the terminal 101 transmits the label to the web server 105 via the web interface 104 in a step S421. Responsive to receiving the label at the web server 105, the web server 105 transmits the label to the application server 106 in a step S422. The processor at the application server 106 is then operative to instruct the validation module to validate the label in a step S423. A plurality of conditions may be specified for the length of the label and for the content of the label. The validation routine compares the label to these conditions in step S423. The validation routine has two flag outputs corresponding to the success or failure of the label in satisfying the conditions specified by the validation routine.

If the validation routine generates the success flag, the label is transmitted to the database server 107 in a step S424 with the request that the label is stored in the location data structure corresponding to location information token 405. Responsive to receiving this request, the DBS stores the label in the location data structure corresponding to location information token 405 in a step S425.

If the validation routine generates the failure output, the application server 106 issues a request to the web server 105 for a valid label in a step S426. Responsive to receiving this request, the web server 105 transmits, via the web interface, a validation failure document to the terminal 101 in a step S427. Responsive to receiving the validation failure document, the processor instructs the application program 111 to display the validation failure document in a step S428. The validation failure document is displayed in a user interface comprising a text box confirming that the label is not valid and that it needs to be re-entered. The user interface also comprises an input region operative to receive an alpha-numeric sequence representing a label for the location information token 405. The user interface also comprises a selectable link marked “Done” which, responsive to selection by the user of the link, transmits the re-entered label to the web server 105 via the web interface in a step S429. Responsive to receiving the re-entered label, the web server 105 repeats steps S423 to S428 until a valid label has been entered and the S423 flag is output as a success, i.e. a valid label has been stored in the corresponding location information data structure 404.

The label stored by the user in S425 provides the user with a meaningful descriptor by which the user would like the location corresponding to the location information token to be known. The label, as it can be specified by the user and stored with the location information token, can be used as a non-unique identifier for a unique location information token with a local, i.e. user's, domain.

For example, a first user may wish to generate a location information token for “61 Drury Lane, London” and a second user may wish to generate a location information token for “122 Drury Lane, London”. The first user may generate the location information token “JN234K” for “61 Drury Lane, London” and the second user may generate the location information token “KL8NM9” for “122 Drury Lane, London”. However, both the first and second user may use the same label, “OFFICE”, say. The label “OFFICE” is significantly easier to recall than the location information token but it is the location information token that is used to index the user's location information corresponding to “61 Drury Lane, London” and “122 Drury Lane, London” respectively. Indexing the relational database using the unique location information token enables a search for location information corresponding to a user to become more efficient as the location information token is an alphanumeric sequence rather than a more complicated piece of location information. However, enabling a label to be stored with each location information token means that the efficient searching can be combined with easy recall to enable to a user to maintain up-to-date and accurate location information which, as will be described later, can be distributed using a label which is easy for the user to recall.

### Generation of Multiple Location Information Tokens

The user token data structure 402 and the location data structure 404 are related under the relational database structure 400 where the location information token 405 is the primary key. The relationship between the user token data structure 402 and the user editable location data structure is one-to-one. As will now be described, each user token data structure may be related to more than one user editable location data structure as a user may generate more than one location information token. A user may also assign a separate label to each of the location information tokens they have generated.

The generation of multiple location information tokens will now be described using the sequence diagram illustrated in FIG. 15b.

A user having a presence in the system can attempt to establish a user session by initialising the application program 111 at the terminal 101 in a step S501. Responsive to the initialisation of the application at the terminal 101, the terminal 101 displays a user interface comprising an input region for the user's password and an input region for the user's user name. The user interface also comprises a selectable link displaying the term “Go” which, responsive to user selection of the link, transmits the contents of the input regions to the web server 105 via the web interface 104 in a step S502.

The web server 105 receives the contents of the input regions and requests confirmation from the database server 107 that the user name corresponds to the password in a step S503. Responsive to receiving this request, the processor at the database server instructs the DBS to query the relational database 400 for a match between the user name and the password in a step S504.

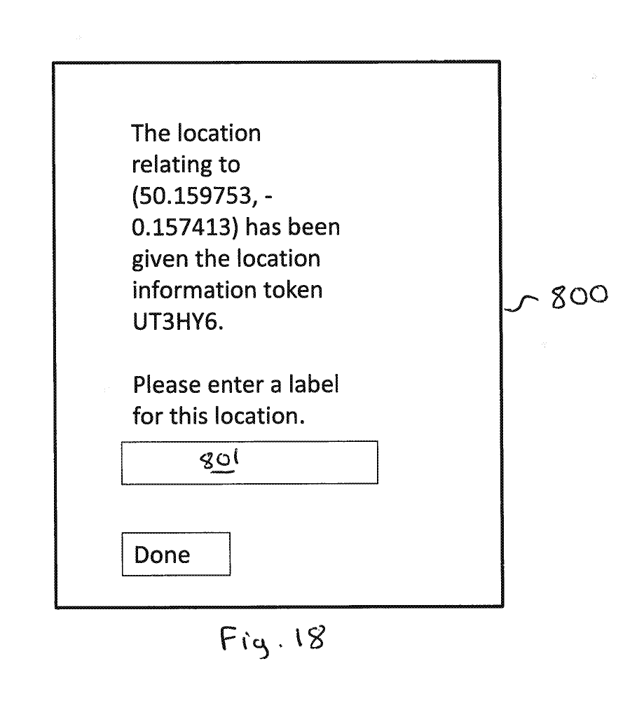

If the query confirms a match in step S504, the DBS outputs a flag to the processor that the user name and password are correct in a step S505. Responsive to the flag being output to the processor in step S505, the database server 107 issues a response to the web server 105 via the database interface 109 to confirm the correspondence between the user name and password in a step S506. Responsive to receiving the response in step S506, a message confirming the presence of the user name on the system and that the password entered at the terminal 101 is correct is transmitted to the terminal in an access confirmation document in a step S507. The confirmation document comprises a message confirming that access to the system has been granted and a plurality of selectable links corresponding to different actions the user may wish to perform using their presence in the system 100. The issuance of the access confirmation document in step S507 establishes the user session in the system 100. Responsive to receiving the access confirmation document, the processor at the terminal 101 instructs the application program 111 to display a user interface confirming access to the system and providing the selectable links for selection by the user. The selectable links comprise links which enable the user to “Upload Third Party Location Information” 901, “Generate Further Location Information Tokens” 902, “Access Location Data” 903 and “Search Location Data” 904. An example user interface 900 is illustrated in FIG. 19.

If the query denies a match in step S504, the DBS outputs a flag to the processor that the user name and password are incorrect. The database server 107 issues a request to the web server 105 for a different user name and password in a step S508. Responsive to receiving the request in step S508, the web server transmits an incorrect password document to the terminal 101 in a step S509. The incorrect password document comprises a message to be displayed to the user at the terminal 101 confirming that the password that was transmitted to the web server 105 in step S502 is incorrect and an input region where a password can be re-entered. The incorrect password document also comprises a selectable link which, responsive to selection of the link, confirms the re-entry of a password and initiates the repetition of steps S502 to S508 until the query in S504 confirms a match, i.e. the S504 flag is correct.

Responsive to user selection of the selectable link “Generate Further Location Information Tokens” 902, the steps carried out in S412 to S417 are repeated to generate a second (or other) location information token and a further location information data structures 404b, c, d, etc corresponding to those corresponding to the second (or other) location information tokens that are generated.

The user may also generate labels for each of the location information tokens that have been generated in accordance with steps S418 to S428.

### Third Party Location Information Tokens

The storage of third party location information tokens will now be described using FIG. 15c.

A user having a presence in the system 100 may establish a user session in accordance with steps S501 to S507 or continue an existing user session to create a store of location information tokens to be stored in the third party location information token data structure 403.

Responsive to establishment of a user session in step S507, the user may select the selectable link “Upload Third Party Location Information” 901 by clicking on the user interface 900. Responsive to selection of this link the terminal issues a request to the web server 105 via the web interface 104 for a location information token store document in a step S512. Selection of this link indicates the user's desire to store third party location information tokens. The third party may be a favourite restaurant, a family member, a garage where the user's car is serviced, or other offices that the user may visit as part of day to day operations.

The web server 105 is operative to respond to the request by transmitting a location information store document retrieved from store 110 comprising at least one input region operative to receive a location information token 405 or a label 406 corresponding to the third party via the web interface 104 in a step S513.

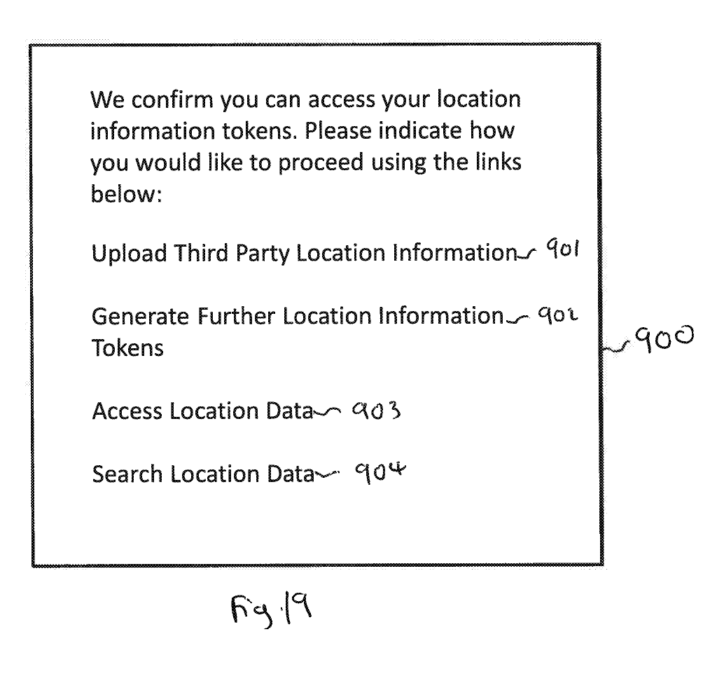

In step S514, the terminal 101 is operative to receive the location information store document from the web server 105 via the web interface 104, the processor, responsive to the terminal receiving the location information store document, instructs the application program 111 to display the location information store document on the terminal in the form of a user interface. An example of such a user interface 1000 is given in FIG. 20. The input region 1001 is operative to receive a location information token or label corresponding to the third party. The user initiates the process of storing the location information token or label by clicking on the region 1002.

Responsive to the user clicking on region 1002, the terminal 101 is operative to transmit the third party location information token or label to the web server 105 via the web interface 104 in a step S515. Responsive to receiving the third party location information token or label, the web server 105 transmits a request in step S516 to the database server 107 for the third party location information token or label to be stored in the third party location information token data structure 403.

The DBS is operative to recognise that the request made in the step S516 relates to a label. In this instance, the DBS is operative to search for location information tokens which use the transmitted label. The DBS will then return the results of the search to the terminal 101 via the web server 105. The user of the terminal can then select which of the third party location information tokens corresponding to the label the user wishes to store. A verification message may be sent to the corresponding third party to verify they have provided the user with the label.

The processor at the database server 107 is operative to instruct the DBS to store the third party location information token or label transmitted in step S515 in the third party location information token data structure 403 in a step S517.

The third party location information data structure 403 comprises a table of third party location information tokens. Each location information token in the table is a pointer to a corresponding location information token data structure.

Responsive to receiving the instructions in step S517, the DBS stores the third party location information token in the third party location information token data structure and reports a confirmation flag confirming the successful storage of the third party location information token to the web server 105 in a step S518.

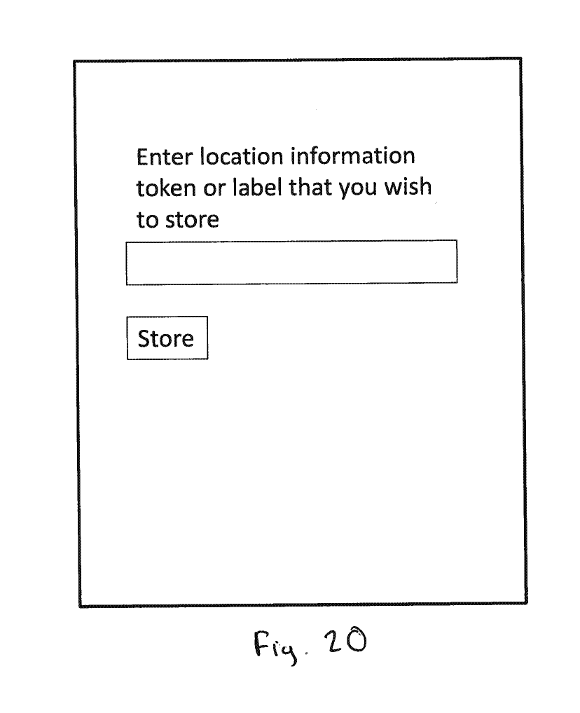

Responsive to receiving the confirmation flag, the web server 105 retrieves the template for the template for the confirmation document from the store 110 in a step S519. The confirmation document comprises a text region populated with a message informing the user that the location information token, e.g. 8UJKL9 has been successfully stored. The confirmation document also comprises an input region 1101 operative to receive alphanumeric input in the form of a label that the user can give to the third party location information token stored in step S515 and a corresponding selectable link 1102 which, responsive to user selection, initiates the storage of the label input into the input region in the third party location information token data structure. A further selectable link 1103 is provided which cancels the labelling process. The web server 105 transmits the confirmation document to the terminal 101 in a step S520. Responsive to receiving the confirmation document, the processor at the terminal 101 instructs the application program 111 to display the confirmation document on the terminal 101 in a step S521. The application is operative to display the confirmation document in the form of a user interface. An example of such a user interface is illustrated in FIG. 21. Responsive to the user selecting “save” on the user interface in FIG. 21 the label entered into input region 1101 is transmitted to the web server 105 via the web interface 104 with a request from the terminal for the label to be stored in a step S522.

Responsive to receiving the request in step S522, the web server 105 transmits the label to the database server 107 in a step S523 with a request for the label to be stored in the third party location information data structure 403 corresponding to the user.

The processor at the database server 107, responsive to receiving the request from the web server 105 in step S523, instructs the DBS to store the label in the third party location information data structure 403. The label is stored as an attribute in the third party location information data structure 403 in a step S524. The DBS then outputs a confirmation flag to the processor at the database server 107 to confirm the storage of the label in the third party location information data structure. Responsive to the output of the flag, the database server 107 transmits a response to the web server 105 to confirm the label has been stored by the DBS in a step S524. The web server 105 is operative to, responsive to receiving the confirmation from the database server 107, to transmit a confirmation document comprising a message confirming the storage of the location information token and the label in a step S525 to the terminal 101. Responsive to receiving the confirmation document, the processor at the terminal 101 is operative to instruct the application program 111 to display the confirmation document in a step S526.

### Accessing and Editing the Location Data

A method of accessing the location data in the relational database 400 will now be described with reference to FIG. 15d

A user who has established a presence in the system in accordance with steps S201 to S232 may already have established a session in the system 100 using terminal 101 and may continue with that session or a user who has established a presence in the system may establish a new session in accordance with steps S501 to S507.

In the following example, the user has already established a session in the system in accordance with steps S501 to S507 and selects from the links illustrated in FIG. 19 the selectable link entitled “Access Location Data” 903.

Responsive to the selection of this link, the terminal 101 transmits a request to the web server 105 via the web interface 104 for a data access document in a step S527. Responsive to receiving the request, the web server 105 issues a request to the database server 107 via the database interface 109 for the location information tokens previously stored by the user in a step S528. The processor at the database server is operative, in a step S529, to instruct the DBS to retrieve from the relational database 400 the location information tokens that have previously been generated in accordance with steps S412 to S417 and the third party location information tokens stored in third party location information token data structure 403. The DBS outputs the location information tokens retrieved from the relational database structure and transmits the location information tokens to the web server 105 in a step S530. The web server then transmits the location information tokens in a data display document to the terminal 101 in a step S531. The data display document transmitted in step S531 comprises two lists of location information tokens corresponding to the location information tokens generated by the user and the third party location information tokens stored by the user in the third party location information data structure.

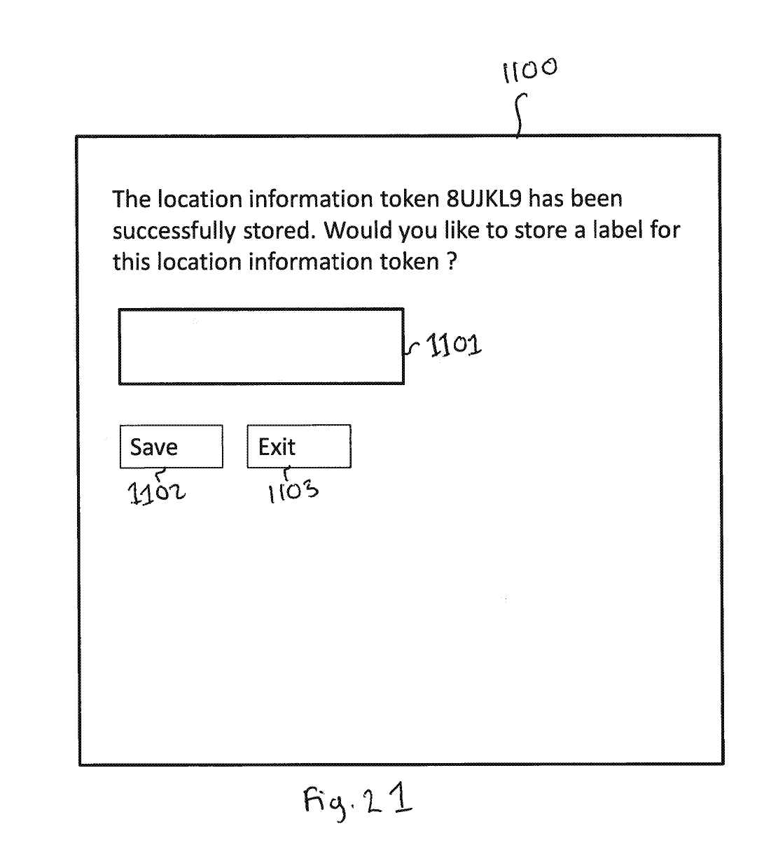

If the user has stored labels for any of the location information data tokens they have generated, they will be displayed on the terminal 101 in place of the location information tokens. This is illustrated in FIG. 22. As the label is at the discretion of the user the label can specify a memorable descriptor for the location which removes the need for the user to remember the location information token, a non-predictively generated sequence of alphanumeric characters, but still enables the user to access the location data corresponding to the unique location information token. In the interface illustrated in FIG. 22, it can be seen that one user generated location information token has been give the label “My House” 1201 and a second user generated location information token has been given the label “Mum's House” 1202. Such labels are much simpler to recall than a non-predictively generated sequence of characters.

The location information tokens or labels may be displayed on the terminal 101 as a list of selectable links which, responsive to selection thereof, initiate the retrieval of the location data corresponding to the location information token or label from the relational database structure.

The display of the location data corresponding to the location information tokens stored in the relational database is now described by reference to sequence diagram FIG. 15e

Responsive to the selection of a link corresponding to a location information token or label therefor, the terminal 101 issues a request to the web server 105 via the web interface 104 for the location data corresponding to that location information token in a step S540. Responsive to receiving the request, the web server 105 transmits the request for the location data to the database server 107 via the database interface in a step S541.

The processor at the database server then supplies the location information token into a data retrieval routine in a step S542 executed by the DBS which retrieves the location data from the location data structure corresponding to the location information token. The DBS then provides a report in the form of the location data corresponding to the location information token. The location data is then transmitted to the web server 105 via the database interface 109 in a step S543. The DBS also outputs a flag value to indicate whether the retrieved location information token is stored in the user token data structure 402, i.e. it is generated by the user, or the location information token is stored in the third party location information data structure 403. The flag value is also transmitted to the web server 105 in step S543.

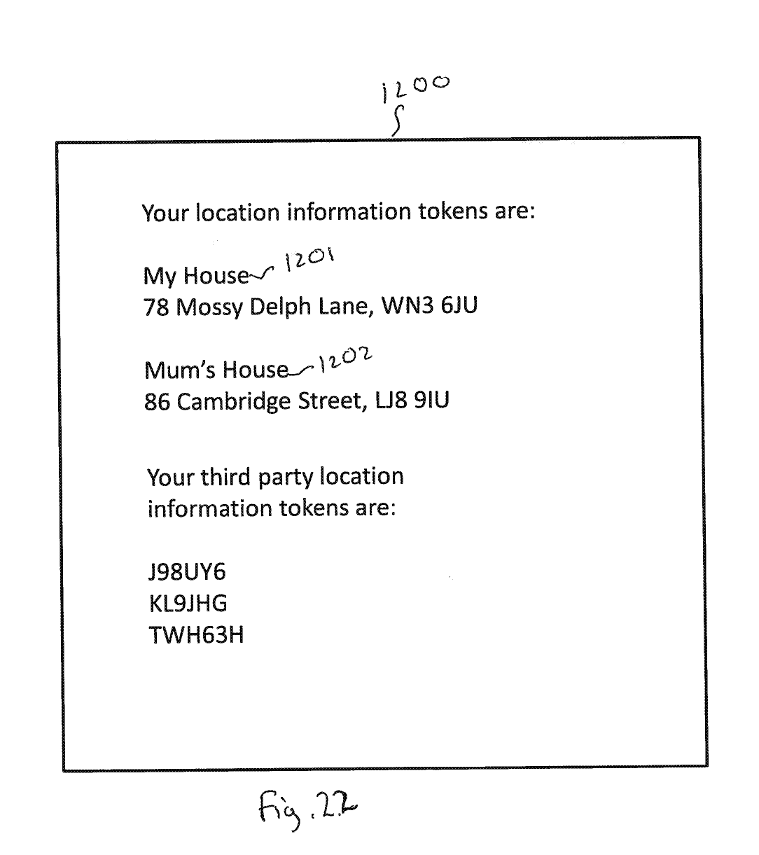

Responsive to receiving the location data from the database server 106, the web server 105 transmits the location data as part of a location data document to the terminal 101 via the web interface. The location data document comprises text regions in which the location data is displayed to the user. If the flag value transmitted in step S543 says that the location information token is user generated, the location information token will be displayed with two selectable links which, when selected, enable the user to edit the location data corresponding to the location information token 405 or delete the location information token 405. If the flag value transmitted in step S543 says that the location information token is not user generated, the location information token will also be displayed with two selectable links which, when selected, enable the user to edit a stored label or delete the location information token 405. The processor 110 at the terminal, in response to receiving the location data document in step S543, is operative to instruct the application program 111 to display the location data document as a user interface. An example of the user interface displayed is illustrated in FIG. 23 with selectable links 1301a and 1301b relating to the selectable links which may be used to respectively “edit” or “delete” the location data relating to the location information token 1301 and selectable links 1302a and 1302b relating to the selectable links which may be used to respectively edit or delete the location data relating to the location information token 1302.

Responsive to user selection of a selectable link corresponding to a location information token the user has generated, i.e. a user generated location information token, the terminal 101 transmits a request to the web server 105 via the web interface 104 for all of the data in the location information token data structure 404 corresponding to the user generated location information token in a step S544. Responsive to receiving the request from the terminal 101, the web server 105 transmits a request to the database server 107 for the location data corresponding to the user generated location information token in a step S545.

The processor at the database server 107 then issues an instruction to the DBS to retrieve the location data corresponding to the user generated location information token in a step S546. The DBS responds to the request in step S545 by retrieving the location data stored in the location data structure corresponding to the user generated location information token and issuing a report containing the location data stored in the location data structure in a step S547. The database server then transmits the location data to the web server in response to the request in step S545 in a step S548.

Responsive to the web server 105 receiving the location data, the web server 105 configures the data display document. The configuration of the display data document comprises retrieving a template of the data display document from the store 112. The web server 105 then populates the display data document with the retrieved location data and transmits the display data document to the terminal 101 via the web interface 104 in a step S549.

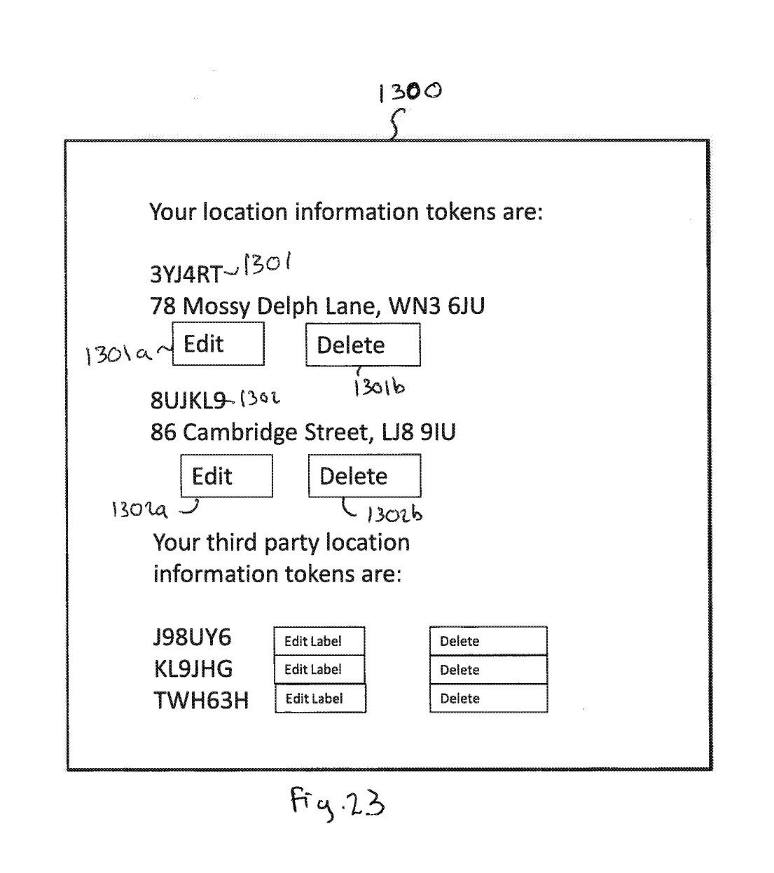

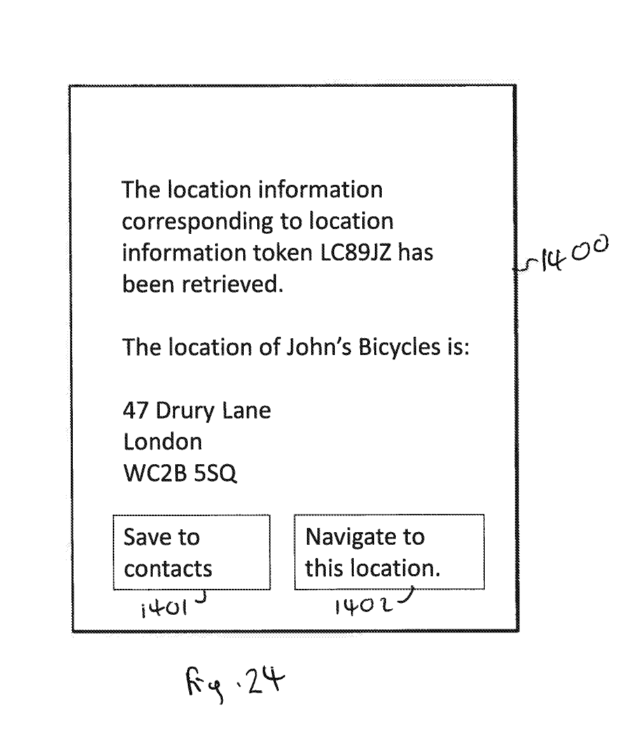

Responsive to receiving the display data document at the terminal 101, the processor at the terminal 110 instructs the application program 111 to display the display data document in the form of a user interface in a step S550. An example of this user interface is illustrated in FIG. 24. The application may interface with another application such as a satellite navigation application to generate directions from the current location to the location indicated by the location data in the displayed display data document. Selectable links are provided on the user interface 1400 to enable the user to save the location data to the contacts list of the terminal 1401 or to interface with a satellite navigation application to obtain directions to the location indicated by the location data 1402.

The editing of location data is now described with reference to FIG. 15f.

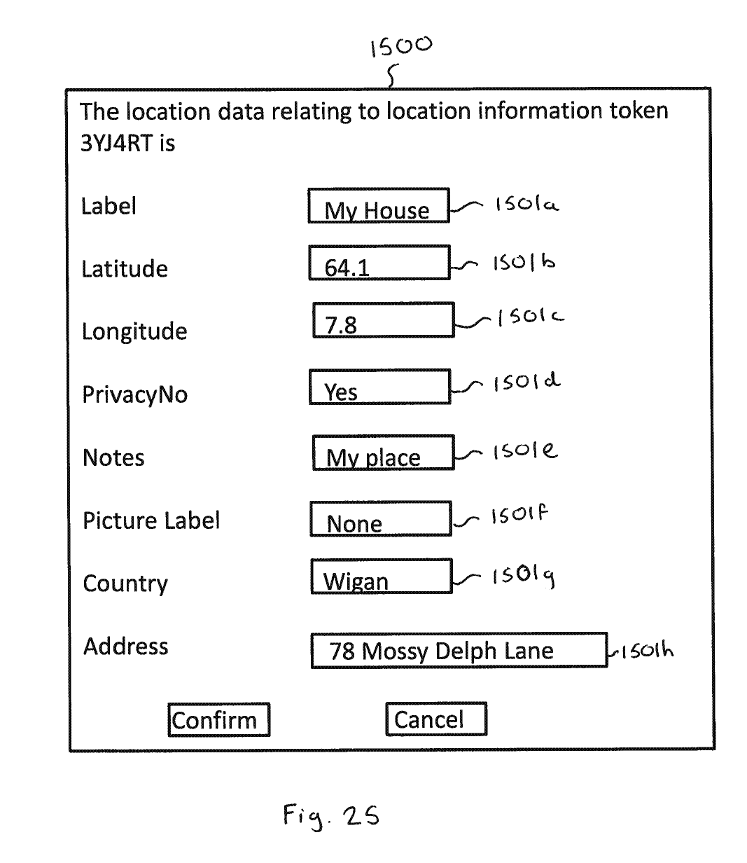

Responsive to the user selecting “edit” on the user interface illustrated in FIG. 23 a request to edit the data stored in the corresponding location information token is transmitted to the web server 105 from the terminal in a step S551. The web server, responsive to the request, issues a request to the database server in a step S552 for the data in the corresponding location information data structure. Responsive to receiving the request in step S552, the processor at the database server instructs the DBS to retrieve the data in the location information data structure. The DBS retrieves the data from the location information data structure 404 in the relational database 400 in a step S553. The database server 107 transmits the data to the web server for display at the terminal in a step S554. The web server retrieves a data edit document template from store 112 and transmits the data edit document to the terminal 101 in a step S555. The data edit document template comprises user input regions 1501 a to h corresponding to each of the attributes in the location information token data structure 404. Each of the user input regions 1501 a to h is populated with the value currently stored for the respective attribute. The data edit document additionally comprises a confirm and cancel selectable link. Responsive to receiving the data edit document from the web server 105, the processor at the terminal 101 instructs the application program 111 to display the data edit document with selectable links corresponding to the confirm and cancel operations in a step S556. An example of the user interface is illustrated in FIG. 25

Each of the attributes, apart from the location information token as that is a primary key for the relational database structure, can be edited by the user. The user may therefore edit the location data and the label corresponding to the location information token and, responsive to selection of the selectable link entitled “confirm”, the data entered in the input regions 1501a to h is transmitted to the web server 105 via the web interface 104 in a step S556 with a request that the data is stored in the location information data structure corresponding to the location information token selected in step S551.

Responsive to the user selecting the selectable link entitled “cancel”, the user interface 1500 illustrated in FIG. 25 is removed from the display.

The effect of the operations in S551 to S556 is that the user can update their location data on the system by storing the new location data using the same location information token. This location information token can then be used by contacts who have that location information token stored in their third party location information data structure to access location data for the user which is up-to-date and accurate without having to iteratively synchronise contact details with contacts. If the contact has a label associated with the third party location information token that label will automatically correspond to the new location through its association or link with the location information token.

### Labelling Third Party Location Information Tokens

If the flag value transmitted in step S543 indicates that the location information token is not user generated, the location information token will also be displayed with two selectable links which, when selected, enable the user to edit a stored label or delete the location information token 405. Responsive to the user indicating they would like to edit a stored label, the process by which a stored label is edited is commenced. The storage of labels for third party location information tokens will now be described with reference to sequence diagram FIG. 15g.

If the user has stored labels for any of the third party location information tokens in accordance with steps S522 to S526, the stored label will also be displayed in place of or in addition to the third party location information token.

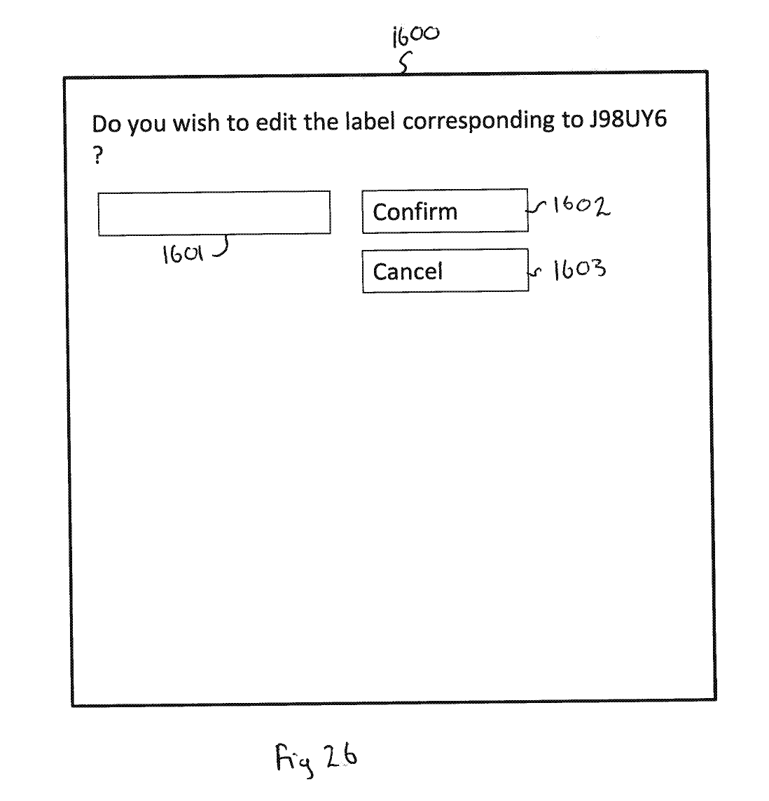

Responsive to selection of the selectable link, the terminal 101 transmits a request to the web server 105 via the web interface 104 in a step S557 for a label edit document. The web server 105 responds to the terminal 101 by retrieving the label edit document from store 112 and transmitting to the terminal 101 the label edit document in a step S558. The web server 105 populates the label edit document with the third party location information token and a user input region operative to receive alpha numeric input prior to transmission in step S558. The processor at the terminal is operative to instruct the software application program 111 to display the label edit document in a step S559 in a user interface. An example of the user interface is illustrated in FIG. 26

The user may input the new label they wish to be stored for the third party location information token into the input region 1601. The user interface also comprises confirm 1602 and cancel 1603 selectable links. Responsive to user selection of the “confirm” selectable link, the terminal transmits the content of user input region 1600 i.e. the new label, to the web server 105 via the web interface 104 in a step S560. Responsive to receiving the new label, the web server 105 transmits the new label to the database server 107 with a request for the new label to be stored in the third party location information data structure 403 in a step S561. Responsive to the database server 107 receiving the request in step S561, the processor at the database server 107 instructs the DBS to store the label in the third party location information data structure 403 in a step S562.

The effect of this arrangement is that the user who generated the third party location information token may store a different label for the third party location information token to the user who is storing the third party location information token. In providing this functionality the system enables the user to create their own domain which enables them to use unique location information tokens to access precise location data relating to contacts they may have without having to recall the location information token corresponding to the precise location data but rather by clicking on a meaningful label which they have given to the location information token. The following example illustrates this effect:

### EXAMPLE 1

Simon has generated a location information token “LC67JV” corresponding to his house at “29 Penfold Street, Warlingham, Surrey”. Simon has stored a label “My House” in the location data structure corresponding to location information token “LC67JV”. Simon has a friend, Peter, who generates a location information token “8UJNHY” corresponding to his house at “18 Quebec Drive, Godstone, Surrey” and has stored the label “My House” in the location information data structure corresponding to location information token “8UJNHY”. Peter also stores the location information token corresponding to Simon's house in his third party location information token data structure. There would be confusion for Peter if the label Simon had stored for his house was displayed on his terminal 101 as the label stored for Simon's house is identical to the label Peter has stored for his house. Therefore, Peter stores the label “Simon's House” for the location information token corresponding to the location of Simon's house whilst when Simon looks at his terminal 101 to review the location information tokens he has stored, he sees the label “My House” corresponding to the location information token for his house.

If the user generated location information token 405 is stored in a third party location information data structure stored by another registered user, when the other registered user wishes to find the location data corresponding to location information token 405, the other registered user can just access their third party location information data structure 403 in which the user generated location information token is stored in accordance with steps S527 to S550 set out in FIG. 15d. The third party location information data structure contains a pointer to the user generated location information token and the corresponding location data. This means that the other user always has an up-to-date store of location data that can be retrieved by storing the location information token corresponding to that location data.

### Searching for Location Data Structures

A user searching for location data structures using the sequence diagram illustrated in FIG. 15h will now be described.

A user having a presence in the system 100 may establish a user session in accordance with steps S501 to S507 or continue an existing user session to search for location data structures that have been stored in the relational database 400.

Responsive to the user selecting the link entitled “Search Location Data” 904, the terminal is operative to issue a request to the web server 105 via the web interface 104 for a searching document in a step S570.

The web server 105 is operative to respond to the request in step S570 by transmitting a search document to the terminal in a step S571. The search document comprises an input region operative to receive a search term. Responsive to receiving the search document at the terminal 101, the processor 110 at the terminal 101 instructs the application program 111 to display the search document in the form of a user interface comprising an input region operative to receive a search term in a step S572.

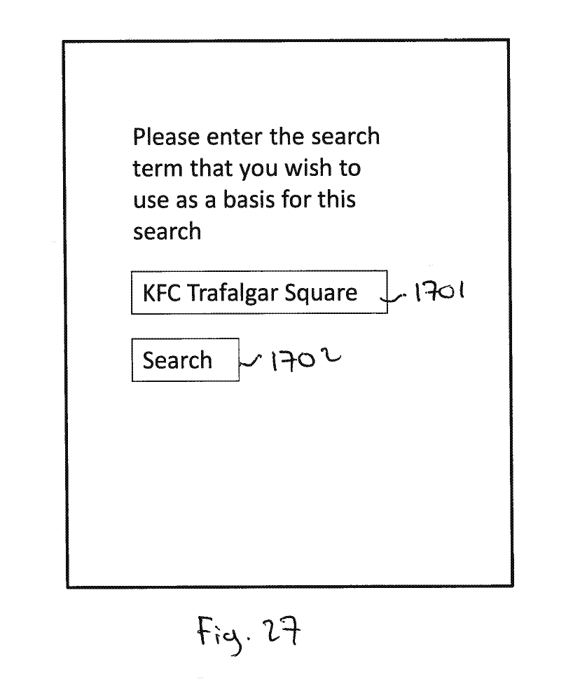

An example user interface is illustrated in FIG. 27.

To initiate the search, the user inputs a search term, for example “KFC Trafalgar Square”, into an input region 1701 and clicks on the region 1702. The search term is then transmitted to the web server 105 via the web interface 104 in a step S573. Responsive to the server receiving the search term, the web server 105 issues a request to the database server 107 via the database interface 109 for all records in the store of location information tokens matching the search term “KFC Trafalgar Square” transmitted in a step S574. Responsive to receiving the request in step S574, the processor at the database server 107 instructs the DBS to query the relational database to find records corresponding to the search term in a step S575. In structuring the database as a relational database, the search for location data corresponding to the search term in step S575 is made more efficient and results from the query will be returned more quickly than for a standard database. Following completion of the query, the DBS returns the results and the database server 107 returns the results to the web server in a step S576. If the query returns a location data structure matching the search criteria, the location information token 405 corresponding to that location data structure is transmitted to the terminal 101 in a step S577 if the privacy flag of that location data structure.

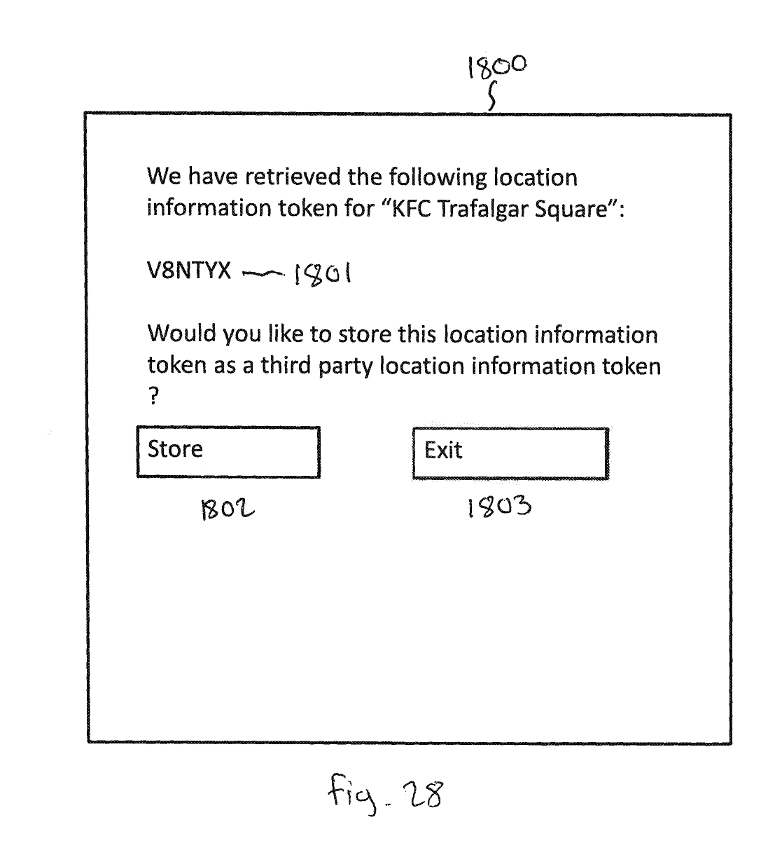

Responsive to receiving the location information token in step S577 the processor 110 at the terminal 101 instructs the application program 111 to display a user interface to the user which invites the user to store the location information token in the third party location information token data structure 403 in accordance with steps S512 to S517. An example user interface 1800 is illustrated in FIG. 28. The user interface comprises a text region 1801 displaying the location information token and two selectable links 1802, 1803 arranged respectively to enable the user to store the location information token displayed in text region 1801 in the third party location information data structure and to enable the user to cancel the search. Responsive to the user input indicating that the user would like to store the location information token, the location information token is stored in the third party location information data structure in accordance with steps S512 to S517.

It is to be understood that any feature described in relation to any one embodiment may be used alone, or in combination with other features described, and may also be used in combination with one or more features of any other of the embodiments, or any combination of any other of the embodiments.

As used herein any reference to “one embodiment” or “an embodiment” means that a particular element, feature, structure, or characteristic described in connection with the embodiment is included in at least one embodiment. The appearances of the phrase “in one embodiment” or the phrase in “in an embodiment” in various places in the specification are not necessarily referring to the same embodiment.

Insofar as embodiments of the invention described above are implementable, at least in part, using a software-controlled programmable processing device such as a general purpose processor or special-purpose processor, digital signal processor, microprocessor, or other processing device, data processing apparatus or computer system it will be appreciated that a computer program for configuring a programmable device, apparatus or system to implement the foregoing described methods, apparatus and system is envisaged as an aspect of the present invention. The computer program may be embodied as any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual Basic, ActiveX, assembly language, machine code and so forth. A skilled person would readily understand that term “computer” in its most general sense encompasses programmable devices such as referred to above, and data processing apparatus and computer systems.

Suitably, the computer program is stored on a carrier medium in machine readable form, for example the carrier medium may comprise memory, removable or non-removable media, erasable or non-erasable media, writeable or re-writeable media, digital or analog media, hard disk, floppy disk, Compact Disk Read Only Memory (CD-ROM), optical disk, magnetic media, magneto-optical media, removable memory cards or disks, various types of Digital Versatile Disk (DVD) subscriber identity module, tape, cassette solid-state memory. The computer program may be supplied from a remote source embodied in the communications medium such as an electronic signal, radio frequency carrier wave or optical carrier waves. Such carrier media are also envisaged as aspects of the present invention.

As used herein, the terms “comprises”, “comprising”, “includes”, “including”, “has”, having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the invention. This is done merely for convenience and to give a general sense of the invention. This description should be read to include one or at least one and the singular also includes the plural unless it is obvious that it is meant otherwise.

In view of the foregoing description it will be evident to a person skilled in the art that various modifications may be made within the scope of the invention. For example, although embodiments have been described using location information as the data other data items may be used such as bank details, security and personal details, legal documentation, investment and financial details. Additionally, privacy and security settings may be implemented so that the information returned from a user editable location information structure may be controlled and distributed according to the desires of the user who generated the location information therein.

Although the location information token is assigned by the DBS as an index it may optionally or additionally be stored in its associated location information data structure such that it may be searched for within the DBS.

The scope of the present disclosure includes any novel feature or combination of features disclosed therein either explicitly or implicitly or any generalisation thereof irrespective of whether or not it relates to the claimed invention or mitigate against any or all of the problems addressed by the present invention. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

Yet further aspects and embodiments of the invention are enumerated with reference to the following numbered clauses.

1. A computer implemented method of creating a first user information token in a computer system, the method comprising:
establishing a first user session for a first user having a presence in the computer system comprising a first user data structure including first user meta data indexed by a first user identity responsive to first user input;
receiving content input by the first user;
generating a unique user information token;
storing the content in a first user modifiable content storage structure locatable by the user information token; and
storing the user information token in a first user token data structure indexed by the first user identity.

2. A computer implemented method according to clause 1, wherein the first user editable content storage structure is indexed by the user information token.

3. A computer implemented method according to clause 1 or 2, wherein the user information token is assigned to the content.

4. A computer implemented method according to any preceding clause, wherein the user information token is stored in the content storage structure.

5. A computer implemented method according to any preceding clause, further comprising updating the content in the content structure responsive to input from the first user.

6. A computer implemented method according to any preceding clause, further comprising receiving from the first user a first character string and assigning the first character string to the information token.

7. A computer implemented method according to any preceding clause, further comprising:
receiving from the first user a unique third party information token indexing a third party content storage structure; and
storing the third-party information token in a third party information token data structure indexed by the first user identity.

8. A computer implemented method according to clause 7, further comprising receiving from the first user a character string and assigning the character string to the third party information token.

9. A computer implemented method of creating a store of information tokens 405, comprising:
establishing a first user session for a first user having a presence in the computer system comprising a first content storage structure including first user meta data indexed by a first user identity;
receiving from the first user an unique third party information token indexing a third party content storage structure; and
storing the third party information token in a third party information token data structure indexed by the first user identity.

10. A computer implemented method according to clause 9, further comprising receiving from the first user a character string and assigning the character string to the third party information token.

11. A computer implemented method of accessing information stored in a computer system comprising a store of information tokens generated in accordance with any of clauses 1 to 8 and/or a store of information tokens created in accordance with clause 9 or clause 10, the method comprising:
receiving a search query comprising one or more search terms;
searching first user data structures and returning at least one user information token 405 stored in an information token data structure indexed by the first user identity.

12. A computer implemented method according to clause 11 dependent on any of clauses 7 to 10, optionally or additionally returning at least one third party information token.

13. A computer implemented method of accessing information stored in a computer system comprising a store of information tokens generated in accordance with any of clauses 1 to 7 and/or a store of information tokens created in accordance with clause 8 or clause 9, the method comprising:
receiving a search query comprising a user or third party information token;
returning content stored in an information data structure indexed by the user or third party information token.

14. A computer implemented method according to any preceding clause, further comprising modifying content stored in a content storage structure identified by an user information token responsive to a request from the user controlling the user information token identifying the content storage structure in which the content to be modified is stored.

15. A computer implemented method according to any preceding clause, further comprising storing meta data about the content stored in a content storage structure in the said content storage structure responsive to a user request.

16. A computer implemented method according to clause 15, further comprising restricting storing the meta data responsive to a request from a user controlling the user information token indexing the said content storage structure.

17. A computer implemented method according to clause 15 or 16, wherein the meta data includes one or more of the following: privacy rules defining rights of access to the content or a part thereof; an image; a QR code; and notes.

18. A computer implemented method according to any preceding clause, wherein the content comprises digital map location data.

19. A computer implemented method according to clause 18 wherein the digital map location data comprises data corresponding to an indicated location on a digital map.

20. A computer implemented method according to clause 18 or 19, wherein the digital map location data comprises satellite navigation location data.

21. A computer implemented method according to any one of clauses 18 to 20, wherein the content comprises meta data for the digital map location data.

22. A computer implemented method according clause 19, wherein the meta data comprises one or more of the following: address data; details of a map provider; and notes, for example a description of the locations as “home” or “home delivery”.

23. A computer implemented method according to clause 1, wherein a first user interface is instantiated on a terminal device separate from the computer system.

24. A computer implemented method according to clause 23, wherein the first user interface is operative to display a digital map on which the first user may indicate a location, the first user interface further operative responsive to first user input to initiate communication of the content containing digital map data corresponding to the location to the computer system.

25. A computer implemented method according to clause 23, wherein the terminal device comprises a satellite navigation service and the first user interface is operative to establish a location using the satellite navigation service and responsive to first user input to initiate communication of the content containing satellite navigation location data corresponding to the location of the terminal device to the computer system.

26. A computer implemented method according to clause 13, further comprising storing the returned information token on a terminal device remote from the computer system.

27. A computer implemented method according to clause 15, further comprising storing the returned one or more items of meta data on a terminal device remote from the computer system.

28. A computer system for creating a first user information token, the system operative to
establish a first user session between a terminal and a server for a first user having a first user data structure on a database stored on the storage medium including first user meta data indexed by a first user identity responsive to first user input at the terminal device;
receive content at the server;
generate a unique user information token at the server;
store the content a first user modifiable content storage structure locatable by the user information token;
store the user information token in a first user token data structure indexed by the first user identity.

29. A computer system according to clause 28, wherein the system is further operative to index the first user editable content storage structure by the user information token.

30. A computer system according to clause 28 or 29, wherein the system is further operative to assign a user information token to the content.

31. A computer system according to any of clauses 28 to 30, wherein the system is further operative to store user information token in the content storage structure.

32. A computer system according to any of clauses 28 to 31, wherein the system is further operative to update the content in the content structure responsive to input from the first user.

33. A computer system according to any of clauses 28 to 32, wherein the system is further operative
to receive from the first user a first character string and to assign the first character string to the information token.

34. A computer system according to any clauses 28 to 33, wherein the system is further operative to receive from the first user a unique third party information token indexing a third party content storage structure; and
store the third-party information token in a third party information token data structure indexed by the first user identity.

35. A computer system according to clause 34, wherein the system is further operative to receive from the first user a character string and to assign the character string to the third party information token.

36. A computer system according to clause 28, wherein the terminal is configured to display a first user interface operative displaying a digital map on which the first user may indicate a location, the first user interface further operative to interpret the indication of a location as an instruction to a location determination circuit to generate the content containing digital map data corresponding to the location.

37. A computer system according to clause 28, wherein the terminal is configured to generate digital map data using a satellite navigation service and the first user interface is operative to establish a location using the satellite navigation service and responsive to first user input to communicate the content containing satellite navigation location data corresponding to the location of the terminal to the server.

38. A computer system according to any of Clauses 28 to 37, the system further operative to:
receive at the server from the terminal a third party location information token;
store the third-party location information token in a third party location information token data structure indexed by the first user identity on the storage medium;
define a relationship between a third party token data structure and a corresponding third party location information data structure through the third party location information token; and
define a relationship between the first user data structure and the third party token data structure through the first user identity.

39. A computer system for creating a store of information tokens, the system operative to:
establish a first user session for a first user having a presence in the system comprising a first content storage structure including first user meta data indexed by a first user identity;
receive from the first user an unique third party information token indexing a third party content storage structure; and
store the third party information token in a third party information token data structure indexed by the first user identity.

40. A computer system according to clause 39, wherein the system is further operative to receive from the first user a character string and to assign the character string to the third party information token.

41. A computer system for accessing information stored in a data store, wherein the system is operative to store information tokens generated in accordance with any of clauses 28 to 38, the system operative to:
receive a search query comprising one or more search terms;
search first user data structures and returning at least one user information token stored in an information token data structure indexed by the first user identity.

42. A computer system according to clause 41 dependent on any of clauses 37 to 40, optionally or additionally returning at least one third party location information token.

43. A computer system for accessing information stored in a data store comprising a store of information tokens generated in accordance with any of clauses 28 to 37 and/or a store of information tokens created in accordance with clause 38 or clause 39, the system operative to:
receive a search query comprising a user or third party information token;
return content stored in an information data structure indexed by the user or third party information token.

44. A computer system according to any of clauses 28 to 43, wherein the system is further operative to modify content stored in a content storage structure identified by an user information token responsive to a request from the user controlling the user information token identifying the content storage structure in which the content to be modified is stored.

45. A computer system according to any of clauses 28 to 44, wherein the system is further operative to store meta data about the content stored in a content storage structure in the said content storage structure responsive to a user request.

46. A computer system according to clause 45, wherein the system is further operative to restrict the storage of the meta data responsive to a request from a user controlling the user information token indexing the said content storage structure.

47. A computer system according to clause 45 or 46, wherein the meta data includes one or more of the following: privacy rules defining rights of access to the content or a part thereof; an image; a QR code; and notes.

48. A computer system according to any of clauses 28 to 47, wherein the content comprises digital map location data.

49. A computer system according to clause 48 wherein the digital map location data comprises data corresponding to an indicated location on a digital map.

50. A computer system according to clause 48 or 49, wherein the digital map location data comprises satellite navigation location data.

51. A computer system according to any one of clauses 48 to 50, wherein the content comprises meta data for the digital map location data.

52. A computer system according to clause 49, wherein the meta data comprises one or more of the following: address data; details of a map provider; and notes, for example a description of the locations as “home” or “home delivery”.

What is claimed is:

1-52. (canceled)

53. A computer implemented method of creating a first user information token in a computer system, the method comprising:
establishing a first user session for a first user having a presence in the computer system comprising a first user data structure including first user meta data indexed by a first user identity responsive to first user input;
receiving content input by the first user;
generating a unique user information token;
storing the content in a first user modifiable content storage structure locatable by the user information token; and
storing the user information token in a first user token data structure indexed by the first user identity.

54. A computer implemented method according to claim 53, wherein the first user modifiable content storage structure is indexed by the user information token.

55. A computer implemented method according to claim 53, wherein the user information token is assigned to the content.

56. A computer implemented method according to claim 53, wherein the user information token is stored in the first user modifiable content storage structure.

57. A computer implemented method according to claim 53, further comprising updating the content in the first user modifiable content storage structure responsive to input from the first user.

58. A computer implemented method according to claim 53, further comprising receiving from the first user a first character string and assigning the first character string to the user information token.

59. A computer implemented method according to claim 53, further comprising:
receiving from the first user a unique third party information token indexing a third party content storage structure; and
storing the third party information token in a third party information token data structure indexed by the first user identity.

60. A computer implemented method according to claim 59, further comprising receiving from the first user a character string and assigning the character string to the third party information token.

61. A computer implemented method of creating a store of information tokens in a computer system, the method comprising:
establishing a first user session for a first user having a presence in the computer system comprising a first user content storage structure including first user meta data indexed by a first user identity;
receiving from the first user a unique third party information token indexing a third party content storage structure; and
storing the third party information token in a third party information token data structure indexed by the first user identity.

62. A computer implemented method according to claim 61, further comprising receiving from the first user a character string and assigning the character string to the third party information token.

63. A computer system for creating a first user information token, the system comprising:
a server, a terminal and a database, the database being stored in a storage medium, wherein the system is operative to:
establish a first user session between the terminal and the server for a first user having a first user data structure on the database including first user meta data indexed by a first user identity responsive to first user input at the terminal device;
receive content at the server;
generate a unique user information token at the server;
store the content in a first user modifiable content storage structure locatable by the user information token; and
store the user information token in a first user token data structure indexed by the first user identity.

64. A computer system according to claim 63, wherein the system is further operative to index the first user modifiable content storage structure by the user information token.

65. A computer system according to claim 63, wherein the system is further operative to assign the user information token to the content.

66. A computer system according to claim 63, wherein the system is further operative to store the user information token in the first user modifiable content storage structure.

67. A computer system according to claim 63, wherein the system is further operative to update the content in the first user modifiable content storage structure responsive to input from the first user.

68. A computer system according to claim 63, wherein the system is further operative to receive from the first user a first character string and to assign the first character string to the user information token.

69. A computer system according to claim 63, wherein the system is further operative to:
receive from the first user a unique third party information token indexing a third party content storage structure; and
store the third party information token in a third party information token data structure indexed by the first user identity.

70. A computer system according to claim 69, wherein the system is further operative to receive from the first user a character string and to assign the character string to the third party information token.

71. A computer system according to claim 63, wherein the terminal is configured to display a first user interface that is operative to display a digital map on which the first user indicates a location, the first user interface further operative to interpret the indication of the location as an instruction to a location determination circuit to generate content that includes digital map data corresponding to the location.

72. A computer system according to claim 63, wherein the terminal is configured to generate digital map data using a satellite navigation service, and a first user interface is operative to establish a location using the satellite navigation service and is responsive to the first user input to communicate satellite navigation location data corresponding to a location of the terminal relative to the server.

73. A computer system according to claim 63, the system further operative to:
receive at the server from the terminal a third party location information token;
store the third party location information token in a third party location information token data structure indexed by the first user identity on the first user modifiable content storage medium;
define a relationship between a third party token data structure and a corresponding third party location information data structure through the third party location information token; and
define a relationship between the first user data structure and the third party token data structure through the first user identity.
